(19) United States
(12) Patent Application Publication
(10) Pub. No.: US 2024/0160945 A1
(43) Pub. Date: May 16, 2024

(54) AUTONOMOUS DRIVING METHODS AND SYSTEMS

(71) Applicant: NANYANG TECHNOLOGICAL UNIVERSITY, Singapore (SG)

(72) Inventors: Chen LYU, Singapore (SG); Jingda WU, Singapore (SG)

(21) Appl. No.: 18/282,417

(22) PCT Filed: Mar. 17, 2022
(86) PCT No.: PCT/SG2022/050148

§ 371 Date: Sep. 15, 2023

(30) Foreign Application Priority Data
Mar. 17, 2021 (SG) 10202102725Q

(51) Int. Cl. G06N 3/092; B60W 60/00

(52) U.S. Cl. CPC G06N 3/092; B60W 60/00

(57) ABSTRACT

A method of training a deep reinforcement learning model for autonomous control of a machine, such as autonomous vehicles, the model being configured to output, by a policy network, an agent action in response to input of state information and a value function, the agent action representing a control signal for the machine. The method comprises minimizing a loss function of the policy network; wherein the loss function of the policy network comprises an autonomous guidance component and a human guidance component (human intervention); and wherein the autonomous guidance component is zero when the state information is indicative of a human input signal.

### TECHNICAL FIELD

The present invention relates, in general terms, to autonomous driving systems, and also relates to autonomous driving methods.

### BACKGROUND

The development of autonomous vehicles (AVs) has gained increasing attention from both academia and industry in recent years. As a promising application domain, autonomous driving has been boosted by ever-growing artificial intelligence (AI) technologies. From the advances made in environment perception and sensor fusion to successes achieved in human-like decision and planning, we have witnessed great innovations developed and applied in AVs. As an alternative option to the conventional modular solution that divides the driving system into connected modules such as perception, localization, planning and control, end-to-end autonomous driving has become promising. Now, it serves as a critical testbed for developing the perception and decision-making capabilities of AI and AVs.

Imitation learning (IL) and deep reinforcement learning (DRL) are the two main branches of learning-based autonomous driving policies with an end-to-end paradigm. Since IL behaviour is derived from the imitation source, i.e., the experts who provide the demonstrations, the performance of the learned policies is limited and is unlikely to surpass that of the experts. DRL, which is another data-driven self-optimization-based algorithm, shows great potential to mitigate the aforementioned issues. The fast scene-understanding and decision-making abilities of humans in complex situations can be presented via real-time human-environment interactions and further help improve the performance of DRL agents.

Nevertheless, existing DRL methods under real-time human guidance still face two main issues. First, long-term supervision and guidance are exhausting for human participants. To adapt to a human driver's physical reactions in the real world, the procedure of an existing DRL algorithm must be slowed down in a virtual environment. The induced extensive training process decreases learning efficiency and leads to negative subjective feelings among humans. Second, existing DRL methods with human guidance usually require expert-level demonstrations to ensure the quality of the data collected and achieve an ideal improvement in performance. However, costly manpower and a shortage of professionals in real-world large-scale applications limit the usage of this type of method. Therefore, the capability of existing approaches, particularly their data-processing efficiency, should be further improved to ensure that human guidance-based DRL algorithms are feasible in practice. In addition, more explorations should be conducted to lower the requirements for human participants in human-guided DRL algorithms.

It would be desirable to overcome all or at least one of the above-described problems.

### SUMMARY

Disclosed herein is a method of training a deep reinforcement learning model for autonomous control of a machine, the model being configured to output, by a policy network, an agent action in response to input of state information and a value function, the agent action representing a control signal for the machine. The method comprises:
minimizing a loss function of the policy network;
wherein the loss function of the policy network comprises an autonomous guidance component and a human guidance component; and
wherein the autonomous guidance component is zero when the state information is indicative of input of a human input signal at the machine.

In some embodiments, the model has an actor-critic architecture comprising an actor part and a critic part. The actor part comprises the policy network.

In some embodiments, the critic part comprises at least one value network configured to output the value function.

In some embodiments, the at least one value network is configured to estimate the value function based on the Bellman equation.

In some embodiments, the critic part comprises a first value network paired with a second value network, each value network having the same architecture, for reducing or preventing overestimation.

In some embodiments, each value network is coupled to a target value network.

In some embodiments, the policy network is coupled to a target policy network.

In some embodiments, the deep reinforcement learning model comprises a priority experience replay buffer for storing, for a series of time points: the state information; the agent action; a reward value; and an indicator as to whether a human input signal is received.

In some embodiments, the machine is an autonomous vehicle.

In some embodiments, the loss function includes an adaptively assigned weighting factor applied to the human guidance component.

In some embodiments, the weighting factor comprises a temporal decay factor.

In some embodiments, the weighting factor comprises an evaluation metric for evaluating a trust-worthiness of the human guidance component.

Disclosed herein is also a method for autonomous control of a machine. The method comprises:
obtaining parameters of a trained deep reinforcement learning model trained by a method according to any one of the above methods of training the deep reinforcement learning model for autonomous control of the machine;
receiving state information indicative of an environment of the machine;
determining, by the trained deep reinforcement learning model in response to input of the state information, an agent action indicative of a control signal; and
transmitting the control signal to the machine.

Disclosed herein is a system for training a deep reinforcement learning model for autonomous control of a machine. The system comprises: storage; and at least one processor in communication with the storage. The storage comprises machine-readable instructions for causing the at least one processor to execute a method according to any one of the above methods of training the deep reinforcement learning model for autonomous control of the machine.

Disclosed herein is also a system for autonomous control of a machine. The system comprising storage; and at least one processor in communication with the storage. The storage comprises machine-readable instructions for causing the at least one processor to execute a method according to any one of the above methods of training the deep reinforcement learning model for autonomous control of the machine.

Disclosed herein is also non-transitory storage comprising machine-readable instructions for causing at least one processor to execute a method according to the methods of training a deep reinforcement learning model for autonomous control of a machine and the method for autonomous control of the machine.

### BRIEF DESCRIPTION OF THE DRAWINGS

Embodiments of the present invention will now be described, by way of non-limiting example, with reference to the drawings in which:

FIG. 1 illustrates an example high-level architecture of the proposed method with real-time human guidance;

FIG. 2 illustrates an example architecture of the adopted deep reinforcement learning algorithm;

FIG. 3 illustrates he overall structure of the policy 202 and value networks of deep reinforcement learning network;

FIG. 4 illustrates the experimental set-up;

FIGS. 5a-5d illustrate the improved training performance of the proposed Hug-DRL method;

FIGS. 6a-6g illustrate the results of the impacts of human factors on DRL training performance;

FIG. 7 illustrates evaluation of the subjective responses to the question on workload during experiments;

FIGS. 8a-8e illustrate the results of the online training performance of the DRL, agent 802 under the human guidance 804 under the proposed method;

FIGS. 9a-9f shows illustration of the fine-tuning stage of the Hug-DRL, IA-RL, and HI-RL, methods;

FIGS. 10a-110f illustrate ablation investigation of the pre-initialization and reward shaping;

FIGS. 11a-11f show schematic diagram of the scenarios for training and testing of the autonomous driving agent;

FIGS. 12a-12g show implementation details of the vanilla imitation learning-based strategy for autonomous driving;

FIGS. 13a-13b show implementation details of the DAgger imitation learning-based strategy 1300 for autonomous driving;

FIGS. 14a-14f illustrate results of the agent's performance under various driving scenarios; and

FIG. 15 is a schematic diagram showing components of an exemplary computer system for performing the methods described herein.

### DETAILED DESCRIPTION

The present invention relates to a real-time human guidance-based deep reinforcement learning (Hug-DRL) method for policy training in an end-to-end autonomous driving case. With the proposed newly designed mechanism for control transfer between humans and automation, humans are able to intervene and correct the agent's unreasonable actions in real time when necessary during the model training process. Based on this human-in-the-loop guidance mechanism, an improved actor-critic architecture with modified policy and value networks is developed. The fast convergence of the proposed Hug-DRL allows real-time human guidance actions to be fused into the agent's training loop, further improving the efficiency and performance of deep reinforcement learning.

Imitation learning (IL) and deep reinforcement learning (DRL) are the two main branches of learning-based autonomous driving policies with an end-to-end paradigm. However, two main inherent issues have been exposed in practical applications. The first issue is the distributional shift; i.e., imitation errors accumulated over time lead to deviations from the training distribution, resulting in failures in control. Some methods, including dataset aggregation imitation learning (DAgger), generative adversarial imitation learning (GAIL), and their derived methods, have been proposed to mitigate this problem. The other issue is the limitation of asymptotic performance. Since IL behaviour is derived from the imitation source, i.e., the experts who provide the demonstrations, the performance of the learned policies is limited and is unlikely to surpass that of the experts. DRL, which is another data-driven self-optimization-based algorithm, shows great potential to mitigate the aforementioned issues. More recently, actor-critic DRL algorithms with more complex network structures have been developed and have achieved better control performance in autonomous driving. In particular, state-of-the-art algorithms, including soft actor-critic (SAC) and twin-delayed deep deterministic policy gradient (TD3), have been successfully implemented in AVs under many challenging scenarios, such as complex urban driving and high-speed drifting conditions.

Although many achievements have been made in DRL methods, challenges remain. The major challenge is the sample or learning efficiency. In most situations, the efficiency of the interactions between the agent and environment is very low, and the model training consumes remarkable computational resources and time. The learning efficiency can be even worse when the reward signal generated by the environment is sparse. Thus, reward-shaping methods have been proposed to improve learning efficiency in a reward-sparse environment. Another challenge is that DRL methods (particularly with training from scratch) exhibit limited capabilities in scene understanding under complex environments, which inevitably deteriorates their learning performance and generalization capability. Therefore, in AV applications, DRL-enabled strategies are still unable to surpass and replace human drivers in handling various situations due to the limited intelligence and ability of these strategies. In addition, some emerging methods have reconsidered human characteristics and attempted to learn from common sense knowledge and neuro-Symbolics to improve machine intelligence. As humans exhibit robustness and high adaptability in context understanding and knowledge-based reasoning, it is promising to introduce human guidance into the training loop of data-driven approaches, leveraging human intelligence to further advance learning-based methods for AVs.

Human intelligence can be reflected in several aspects of DRL training, including human assessment, human demonstration, and human intervention. Some researchers have made great efforts to introduce human assessments into DRL training and have indeed succeeded in related applications, such as simulation games and robotic action control. However, these methods struggle to handle many other more complex application scenarios where explicit assessments are unavailable. Instead, humans' direct control over and guidance for agents could be more efficient for algorithm training. This gives rise to the architecture of incorporating DRL with learning from demonstration (LfD) and learning from intervention (LfI), which involve ILs such as vanilla-IL and inverse reinforcement learning. Within this framework, representative algorithms are proposed based on DQL and DDPG. Some associated implementations in robotics are then reported, demonstrating improved performance compared to original reinforcement learning. However, these methods are still far from mature. They either directly replace the output actions of DRL by using human actions or use supervised learning (SL) with human demonstrations to pre-train the DRL agent, while the learning algorithm architecture remains unchanged. Recently, attempts have been made to modify the structure of DRL. By redefining policy functions and adding behavioural-cloning objectives, the new DRL schemes are able to effectively accelerate the training process of DRL by leveraging offline human experience. However, compared to offline human guidance, real-time human guidance-based schemes would more efficiently train a DRL agent. For offline human guidance-based DRLs, it is difficult to design a threshold beforehand for human intervention due to the involvement of many non-quantitative factors. Instead, the fast scene-understanding and decision-making abilities of humans in complex situations can be presented via real-time human-environment interactions and further help improve the performance of DRL agents.

The present invention implements the Hug-DRL framework that effectively leverages human intelligence in real time during model training. A real-time Hug-DRL method is developed and successfully applied to agent training under autonomous driving scenarios. Under the proposed architecture, a dynamic learning process leveraging human experience aims to optimize the learning efficiency and performance of an off-policy DRL agent. In some embodiments, in each learning step an evaluation module weights the human guidance actions and the DRL agent's actions according to their respective utilities.

More specifically, the present invention relates to a method for autonomous control of a machine. The method comprises obtaining parameters of a trained deep reinforcement learning model trained for autonomous control of the machine. To apply the model, the method comprises: receiving state information indicative of an environment of the machine; determining, by the trained deep reinforcement learning model in response to input of the state information, an agent action indicative of a control signal; and transmitting the control signal to the machine.

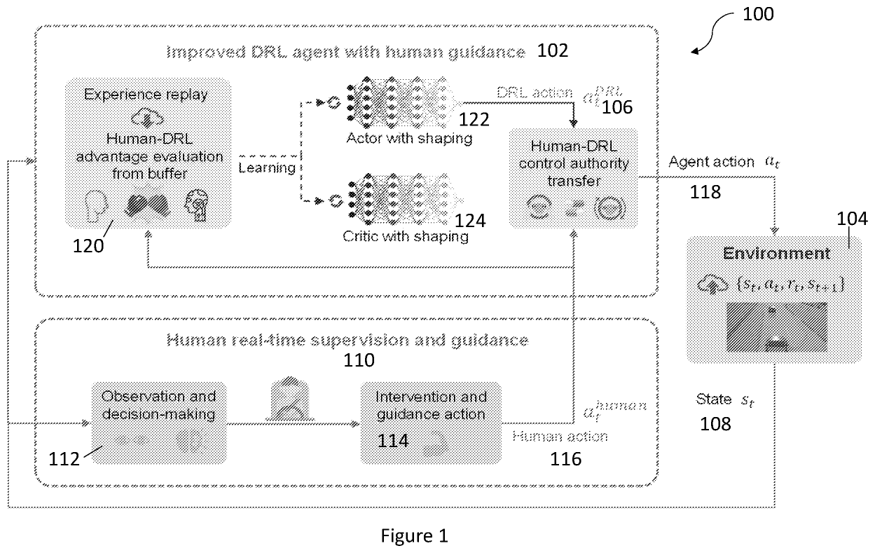

An example high-level architecture 100 of the proposed method with real-time human guidance is illustrated in FIG. 1. The concept behind this prototype is extensively applicable beyond the specific scenarios contemplated herein. In the proposed human-in-the-loop DRL framework 100, similar to the standard DRL architecture, the agent 102 interacts with the environment 104 during training in the autonomous driving scenario. The environment 104 receives the output action 106 of the agent 102 and generates feedback. The feedback includes the state transition 108 and reward (not shown). In the meantime, the DRL agent 102 receives and stores the state 108 sent from the environment 104. The DRL agent 102 keeps optimizing its action-selection policies to improve the control performance. Beyond this, the proposed method introduces real-time human guidance 110 into the im-proved DRL architecture to further enhance the agent 102's learning ability and performance. Specifically, the human participant 110 observes the agent 102's training procedure in real-time (i.e., 112) and overrides the control of the agent (i.e., 114). Control may be overridden by operating the steering wheel to provide guidance 116 when necessary—the necessity to override may be a human decision. The provided human-guidance action 116 replaces the action 106 from the DRL policy and is used as the agent's output action 118 to interact with the environment 104. In the meantime, human actions 116 are stored in the experience replay buffer 120.

Training occurs using a system, such as system 1500, configured for training a deep reinforcement learning model for autonomous control of a machine. The system 1500 will typically comprise storage 1504 and at least one processor 1510 in communication with the storage 1504. The storage 1504 comprises machine-readable instructions for causing the at least one processor 1510 to execute a method of training the deep reinforcement learning model for autonomous control of the machine, to implement the functionality set out with reference to FIG. 1.

As shown in FIG. 1, the trained deep reinforcement learning model has an actor-critic architecture comprising an actor part 122 and a critic part 124. In the actor-critic algorithm, the update of the actor networks 122 and critic networks 124 is modified to be compatible with the human guidance 110 and experience of the DRL agent 102. The actor part 122 may comprise one or more networks. Presently, the actor part 122 comprises a policy network (not shown). The actor network 122 learns from both the human guidance through imitation learning and the experience of interactions through reinforcement learning. Similarly, the critic part 124 may comprise one or more networks. Presently, the critic part 124 comprises at least one value network (not shown) configured to output the value function. The critic network 124 evaluates both the values of the agent's actions and human-guidance actions. By introducing human-guidance actions 116 into both real-time manipulation and offline learning process, the training performance is expected to be significantly improved.

The detailed algorithms, experimental results, and methodology adopted are reported below. The present invention relates to a method of training a deep reinforcement learning model for autonomous control of a machine, the model being configured to output, by said policy network, an agent action in response to input of state information and a value function, the agent action representing a control signal for the machine. The method comprises minimizing a loss function of the policy network. The loss function of the policy network comprises an autonomous guidance component and a human guidance component. The autonomous guidance component is zero when the state information is indicative of input of a human input signal at the machine.

In typical applications of DRL, such as autonomous driving, the control of the DRL agent can be formulated as a Markov decision process (MDP), which is represented by a tuple [symbol] , including state space S∈ [symbol] ⁿ, action space A∈ [symbol] ^{m}, transition model [symbol] : [symbol] × [symbol] → [symbol] , and reward function [symbol] : [symbol] × [symbol] → [symbol] , as

[symbol]

=( [symbol] ) (1)

At a given step, the agent executes an action aₜ∈ [symbol] in a given state sₜ∈ [symbol] and receives a reward rₜ˜ [symbol] (sₜ, aₜ). Then, the environment transitions into a new state sₜ₊₁∈ [symbol] according to the environmental dynamics [symbol] (⋅|sₜ, aₜ). In the autonomous driving scenario, the transition probability model [symbol] for environmental dynamics is difficult to formulate. Thus, embodiments of the present invention adopt model-free reinforcement learning, which does not require the transition dynamics to be modelled, to solve this problem.

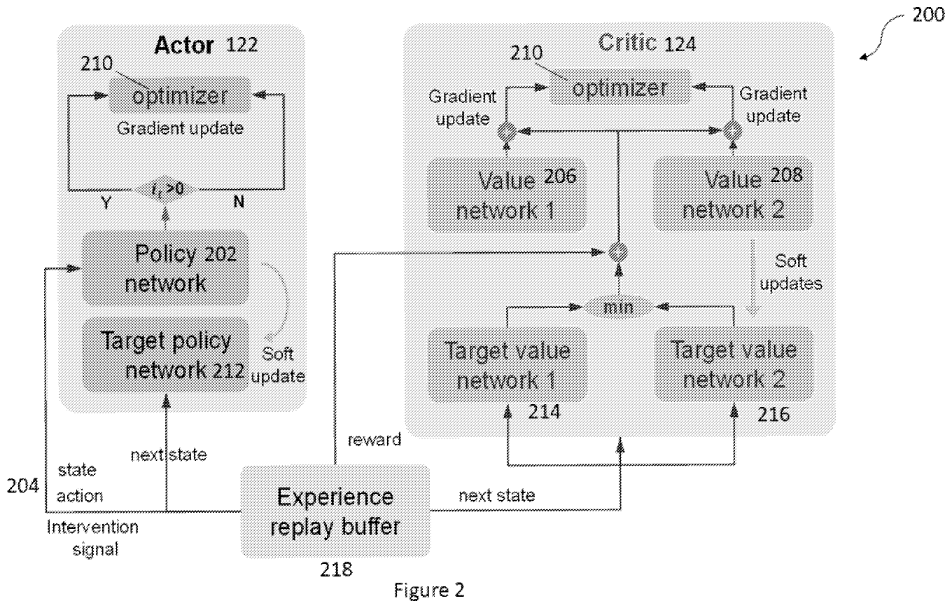

A state-of-the-art off-policy actor-citric method, i.e., TD3, is used to construct the high-level architecture. FIG. 2 illustrates an example architecture 200 of the adopted deep reinforcement learning algorithm, i.e., the TD3 algorithm. Within the actor-critic principle, the policy network 202 of the actor part 122 conducts the control task based on the state input 204, and the value networks 206 and 208 generate evaluations that help to optimize the policy network 202 using the optimizer 210. The TD3 algorithm chooses a deterministic action through policy network μ 202, adjusting action-selection policy π under the guidance of value network Q 206/208. As mentioned above, the critic part 124 may comprise at least one value network configured to output the value function. In some embodiments, the at least one value network is configured to estimate the value function based on the Bellman equation. In particular, the value network approximates the value of the specific state and action based on the Bellman equation. Next, TD3 sets two value networks, Q₁ 206 and Q₂ 208, to mitigate the overestimation issue. To smooth the learning process, target policy networks μ′ 212, Q₁′ 214, and Q₂′ 216 are adopted.

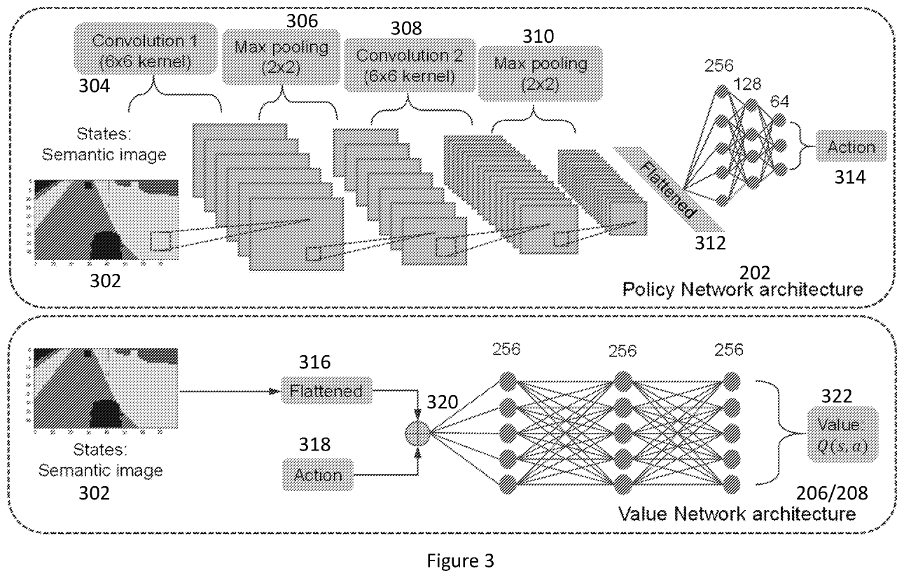

The overall structure of the policy 202 and value networks 206/208 of deep reinforcement learning network is shown in FIG. 3. The semantic images 302 are fed to both the policy 202 and value networks 206/208. The policy network 202 processes images with two convolution-pooling operations. The first convolution-pooling operation consists of Convolution 1 (i.e., 304) and the first Max pooling (i.e., 306). The second convolution-pooling operation consists of Convolution 2 (i.e., 308) and the second Max pooling (i.e., 310). The policy network 202 then flattens the data (see 312) and sends the extracted features to the fully connected layers, that eventually output the control action 314. The value networks 206/208 receive both images 302 and action 318. Images 302 are directly flattened (see 316) and are concatenated with action 314, and the concatenated data (320) is processed with three fully connected layers, that eventually output the value 322.

To realize the human-in-the-loop framework within the reinforcement learning algorithm, the present disclosure combines LfD and LfI into a uniform architecture where humans can decide when to intervene and override the original policy action and provide their real-time actions as demonstrations. Thus, an online switch mechanism between agent exploration and human control is designed. Let [symbol] (sₜ)∈ [symbol] ⁿ denote a human's policy, and the human intervention guidance is formulated as a random event I(sₜ) with the observation of the human driver to the current states. Then, agent action aₜ can be expressed as

aₜ=I(sₜ)·aₜ^{human}+[1−I(sₜ)]·aₜ^{DRL} (2a)

aₜ^{DRL}=clip(μ(sₜ|Θ^{μ})+clip(∈,−c,c), a_{low},a_{high})∈˜ [symbol] (0, σ) (2b)

where aₜ^{human}∈ [symbol] is the guidance action given by a human, aₜ^{DRL} is the action given by the policy network, and I(sₜ) is equal to 0 when there is no human guidance or 1 when human action occurs. Θ^{μ} denotes the parameters of the policy network. a_{low} and a_{high} are the lower and upper bounds of the action space, ∈ is noise subject to a Gaussian distribution, and c is the clipped noise boundary. The purpose of adding Gaussian noise is to incentivize explorations in the deterministic policy. The mechanism designed by Eq. (2a) is to fully transfer the driving control authority to the human participant whenever he or she feels it is necessary to intervene in an episode during agent training.

The value network approximates the value function, which is obtained from the expectation of future reward as

$${Q}^{π} ( s , a ) = {𝔼}_{s ∼ 𝒯 , a ∼ π ( \cdot \vert s )} [ {\sum }_{i}^{∞} {γ}^{i} \cdot {r}_{i} ] \qquad ( 3 )$$

where γ is the discount factor to evaluate the importance of future rewards, and [symbol] [⋅] denotes the mathematical expectation. Let Q (s, a) be the simplified representation for Q^{π} (s, a), and the superscript regarding the policy is omitted unless specified.

To solve the above expectation, the Bellman equation is employed, and the expected iterative target of value function [symbol] at step t can be calculated as

$${𝓎}_{T} = {r}_{t} + γ {min}_{i = 1 , 2} {Q}_{i}^{′} ( {s}_{t + i} , {μ}^{′} ( {s}_{t + 1} \vert {Θ}^{{μ}^{′}} ) \vert {Θ}^{{Q}_{i}^{′}} ) \qquad ( 4 )$$

where Θ^{μ′} denotes the parameters of the target policy network, and Θ^{Q′} refers to the parameters of the target value networks.

In some embodiments as shown in FIG. 2, the critic part 124 comprises a first value network 214 paired with a second value network 208. Each value network has the same architecture, for reducing or preventing overestimation. In other embodiments, multiple values networks (e.g. two value networks) may have different architectures. The two value networks 206 and 208 with the same structure or architecture aim to address the overestimation issue through clipped functionality. In some embodiments, each value network is coupled to a target value network 214/216, and the policy network 202 is coupled to a target policy network 212.

Additionally, target policy network μ′ 212, rather than policy network μ 202, is used to smooth policy updates. Then, the loss function of the value networks in TD3 is expressed as

$${ℒ}^{{Q}_{i}} ( {Θ}^{{Q}_{i}} ) = {𝔼}_{( {s}_{t} , {a}_{t} , {r}_{t} , {s}_{t + 1} ) ∼ 𝒟} [ {‖ {𝓎}_{t} - {Q}_{i} ( {s}_{t} , {a}_{t} \vert {Θ}^{{Q}_{i}} ) ‖}^{2} ] \qquad ( 5 )$$

where Θ^{Q}^{ᵢ} denotes the parameters of the value networks, and [symbol] denotes the experience replay buffer 218, which consists of the current state, the action, the reward, and the state of the next step. To be specific, the deep reinforcement learning model comprises a priority experience replay buffer 218 for storing, for a series of time points: the state information; the agent action; a reward value; and an indicator as to whether a human input signal is received.

The policy network 202 that determines the control action is intended to optimize the value of the value network 206/208, i.e., to improve the control performance in the designated autonomous driving scenario. Thus, the loss function of the policy network 202 in the TD3 algorithm is designed as

$${ℒ}^{μ} ( {Θ}^{μ} ) = - 𝔼 [ {Q}_{1} ( {s}_{t} , {a}_{t}^{DRL} ) ] = - {𝔼}_{{s}_{t} ∼ 𝒟} [ {Q}_{1} ( {s}_{t} , μ ( {s}_{t} \vert {Θ}^{μ} ) ] \qquad ( 6 )$$

The above formula indicates that the expectation for the policy is to maximize the value of the value network 206/208, which corresponds to minimizing the loss function of the policy network 202. The unbiased estimation of aₜ^{DRL} is equal to that of μ(sₜ|Θ^{μ}) since the noise in Eq. (2b) is of a zero-mean distribution.

When human guidance aₜ^{human} 116 occurs, the loss function of the TD3 algorithm should be revised accordingly to incorporate it with human experience. Thus, the value network 206/208 in Eq. (5) can be re-written as

$${ℒ}^{Q} ( {Θ}^{Q} ) = {𝔼}_{( {s}_{t} , {a}_{t} , {r}_{t} , {s}_{t + 1} ) ∼ 𝒟} [ {( {𝓎}_{t} - Q ( {s}_{t} , {a}_{t}^{human} \vert {Θ}^{Q} ) )}^{2} ] \qquad ( 7 )$$

In fact, the mechanism shown in Eq. (7) modified from Eq. (4) is sufficient for establishing a human guidance-based DRL scheme, which has been validated and reported in existing studies. However, merely modifying the value network 206/208 without updating the loss function of the policy network 202 would affect the prospective performance of human guidance 116, because the value network 206/208 is updated based on {sₜ, aₜ^{human}}, whereas the policy network still relies on {sₜ,μ(sₜ|Θ^{μ}}. This would lead to inconsistency in the updating direction of actor and critic networks.

To address the above inconsistency issue, the loss function of the policy network 202 shown in Eq. (6) is modified by adding a human guidance term as

$${ℒ}^{μ} ( {Θ}^{μ} ) = {𝔼}_{\{ {s}_{t} , {a}_{t} , I ( {s}_{t} ) \} ∼ 𝒟} \{ - {Q}_{1} ( {s}_{t} , {a}_{t} ) + I ( {s}_{t} ) \cdot {ω}_{I} \cdot {[ {a}_{t} - μ ( {s}_{t} \vert {Θ}^{μ} ) ]}^{2} \} \qquad ( 8 )$$

where ω_{I} is a factor for adjusting the weight of the human supervision loss, and aₜ^{DRL} in Eq. (6) can then be simply replaced with aₜ, which covers both human actions and DRL policy actions. In this way, the updated direction is aligned with {sₜ, aₜ^{human}} when human guidance occurs. In the present disclosure, the loss function includes an adaptively assigned weighting factor applied to the human guidance component. The weighting factor ω_{I} comprises a temporal decay factor. It may also comprise an evaluation metric for evaluating trustworthiness of the human guidance component. This evaluation metric enables the good or bad extent of the human guidance component to be identified.

In some human-guided frameworks, conversion between the original objective and the human guidance term is conducted rigidly and the weighting factor of the human guidance term is manually set and fixed. However, the weighting factor ω_{I} is crucial for the overall learning performance of a DRL algorithm, as it determines the degree of reliance of the learning process on human guidance. Thus, proposed is an adaptive assignment mechanism for factor ω_{I} that is associated with the trustworthiness of human actions. To do this, the Q advantage is introduced as an appropriate evaluation metric, and the proposed weighting factor can be modified as set out in Equation (9).

ω_{I}=λ⁵·{max[exp(Q₁(sₜ,aₜ)−Q₁(sₜ,μ(sₜ|Θ^{μ}))),1]−1} (9)

where λ is a hyperparameter that is slightly smaller than 1, and k is the index of the learning episode. Temporal decay factor λ^{k} indicates that the trustworthiness of human guidance decreases when the policy function gradually matures. The clip function guarantees that the policy function learns only from “good” human guidance actions, and the exponential function amplifies the advantages brought by those “good” human guidance actions. Thus, the proposed weighting factor is modified using an advantage function based on Q values of the human guidance component and deterministic action.

Intuitively, the adaptive weighting factor proposed above adjusts the trustworthiness of the human experience by quantitatively evaluating the potential advantages of the human's actions compared to those of the original policy. This mechanism forms the dynamic loss function of the policy network instead of a fixed learning mechanism with manually tuned weighting factors. Since the factor aptly distinguishes the varying performances of different human guidance actions, the requirements on the quality of human demonstration, i.e., humans' proficiency and skills, can be eased. Additionally, although the weighting mechanism involves differentiable information with respect to both the critic and actor networks, the calculation of the weighting vector does not participate in the gradient backpropagation updating of the neural networks. Therefore, it will not disturb the network training process. This therefore provides an updating mechanism adaptive to trustworthiness in human experience in LfD/LfI-based reinforcement learning approaches.

Based on Eq. (9), the batch gradient of the policy network 202 can be given by

$${∇}_{{Θ}^{μ}} {L}^{μ} = \frac{1}{N} {\sum }_{t}^{N} \{ ( - {∇}_{a} {Q}_{1} ( s , a ) {\vert}_{s = {s}_{t} , a = μ ( {s}_{t} )} {∇}_{{Θ}^{μ}} μ ( s ) {\vert}_{s = {s}_{t}} ) + ( {∇}_{{Θ}^{μ}} ( {ω}_{I} \cdot {‖ a - μ ( s ) ‖}^{2} ) {\vert}_{s = {s}_{t} , a = {a}_{t}} ) \cdot I ( {s}_{t} ) \} \qquad ( 10 )$$

where N is the batch size sample from experience replay buffer [symbol] .

Although the proposed objective function of the policy network 202 looks similar to the control authority transfer mechanism of real-time human guidance shown in Eq. (2), the principles of these two stages, namely, real-time human intervention and off-policy learning, are different in the proposed method. More specifically, for real-time human intervention, the rigid control transfer illustrated by Eq. (2) enables the human's full takeover when human action occurs. For off-policy learning, weighted trustworthiness is assigned to human guidance without fully discarding the agent's autonomous learning, as shown in Eq. (8)-(10), allowing the learning process to be more robust.

Last, the originally stored tuple of the experience replay buffer is changed and the human guidance component is then included as

[symbol]

={sₜ,aₜ,rₜ,sₜ₊₁,I(sₜ)}. (11)

In this way, the refactored DRL algorithm with real-time human guidance is obtained. The hyperparameters used and the algorithm procedure are provided in Table 1 and Table 2, respectively. Table 1 illustrates Hyperparameters used in the DRL algorithms. These parameters are universally applied to all involved DRL algorithms. Table 2 illustrates the architecture of the proposed Hug-DRL algorithm.

TABLE 1

| Parameter | Description (unit) | Value |
|---|---|---|
| Replay buffer size | The capacity of the experience replay buffer | 384000 |
| Maximum steps | Cutoff step number of the “cold- | 50000 |
| | start” training process | |
| Minibatch size (N) | Capacity of minibatch | 128 |
| Learning rate | Initial learning rate (policy/actor | 0.0005 |
| of actors | networks) with Adam optimizer | |
| Learning rate | Initial learning rate (value/critic | 0.0002 |
| of critics | networks) with Adam optimizer | |
| Initialization | Initialization method of Dense layers | he_initializer |
| | of the network | |
| Activation | Activation method of layers of the network | relu |
| Initial exploration | Initial exploration rate of noise in ϵ - greedy | 1 |
| Final exploration | Cutoff exploration rate of noise in ϵ - greedy | 0.01 |
| Gamma (γ) | Discount factor of the action-value | 0.95 |
| | function of value network | |
| Soft | Parameter transferring speed from | 0.001 |
| updating | policy/value networks to target | |
| factor | policy/value networks | |
| Noise scale | Noise amplitude of action in TD3 algorithm | 0.2 |
| Policy delay (d) | Updating frequency of value networks | 1 |
| | over policy networks | |

TABLE 2
Algorithm S1 Hug-DRL

```
  Initialize the critic networks Q₁, Q₂, and actor network μ with random parameters.
  Initialize the target networks with the same parameters as their counterparts. Initialize experience
replay buffer D.
  Initialize experience replay buffer D
  for epoch = 1 to M do
      for t = 1 to T do
    if the human driver does not intervene
          let I(sₜ) = 0, and select action with exploration noise αₜ ← αₜ~μ(sₜ) + ϵ, with ϵ~ [symbol]   (0,σ)
    Otherwise
          let I(sₜ) = 1, and adopt human action αₜ ← αₜ^{human}
    Observe reward rₜ and the new state sₜ₊₁ , terminal signal dₜ , store transition tuple
      {sₜ, αₜ, rₜ, dₜ, sₜ₊₁, I(sₜ)} in buffer D
    Sample minibatch of N tuples from D, calculate the target value of critic network as
yᵢ ← rᵢ + γ(1 − dᵢ) min_{j=1,2} Q^{′}ⱼ (sᵢ₊₁,μ^{′} (sᵢ₊₁)) , and update the critic networks by: θ^{Qj} ←
ar gmin_{_{θ}}_{Qj}N⁻¹ Σᵢ^{N} (yᵢ − Qⱼ(sᵢ, αᵢ))²
    if t mod d then
      Update the policy network μ by the proposed loss function:
      ∇_{θμ}L^{μ} = N⁻¹{(−∇_{α}Q₁(s, α)|ₛ₌ₛ_{ₜ}_{,α=μ(s}_{ₜ}₎∇_{Θμ}μ(s)|ₛ₌ₛ_{ₜ}) + (∇_{_{Θ}}_{μ} (ω_{I} · ∥α − μ(s) ∥² )|ₛ₌ₛ_{ₜ}_{,α=α}_{ₜ}) · I(sₜ)}
      where ω_{I} = λ^{k} · {max[sup(sₜ,αₜ)_{ϵD} exp(Q₁(sₜ,αₜ) − Q₁(Sₜ,μ(Sₜ|Θ^{μ}))) , 1] − 1}.
      Update the target networks:
      θ^{Q′} ← τθ^{Q} + (1 − τ)θ^{Q′} for both target critic networks.
      θ^{μ′} ← τθ^{μ} + (1 − τ)θ^{μ′} for the target actor network.
    end if
      end for
end for
```

The developed method was validated by human-in-the-loop experiments with 40 subjects and compared with other state-of-the-art learning approaches. The results suggest that the proposed method can effectively enhance the training efficiency and performance of the deep reinforcement learning algorithm under human guidance without imposing specific requirements on participants' expertise or experience.

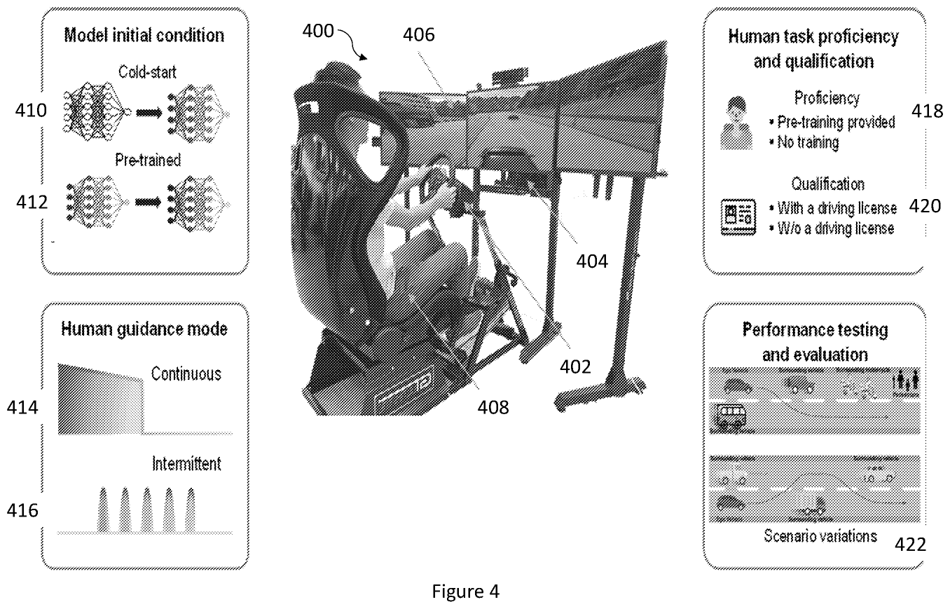

FIG. 4 illustrates the experimental set-up. The experimental platform is a human-in-the-loop driving simulator 400. Key components used in the platform include a steering wheel 402 controlled by a human participant 408, a real-time computation platform 404, three monitors, and simulated driving scenarios 406 in the monitors. As shown in FIG. 4, there are two different model initial conditions of the DRL agent during training, namely the ‘cold-start’ (i.e., 410) and ‘pre-trained’ (i.e., 412). The condition of cold-start is used in the initial training of the DRL agent, and the condition of the pre-trained policy is used for evaluating the fine-tuning performance of the DRL agent.

There are two different modes of the human intervention and guidance, namely the continuous mode (414) and intermittent modes (416). Human task proficiency (418) and driving qualifications (420) are selected as two human factors the impact of which on the training performance of the proposed Hug-DRL method is analysed. Various driving scenarios are also designed in the experiments for testing the control performance of the autonomous driving policies obtained by different DRL methods (see 422 of FIG. 4).

Table 3 illustrates the six experiments (i.e., Experiments A-F). The numbers for illustrating the reward shaping scheme are: 0 stands for no shaping; 1 to 3 stand for three different reward shaping techniques (shaping techniques 1-3), respectively.

TABLE 3

| | Proficient | Qualified | Pre- | Reward | Model | | |
|---|---|---|---|---|---|---|---|
| f | human | human | initializing | shaping | initial | Training/ | |
| Method | participant | participant | trick | scheme | condition | Testing | |
| Hug-DRL | Both | Both | Y | 1 | Cold-start | Training | Experiment A |
| IA-RL | Both | Both | Y | 1 | Cold-start | Training | |
| HI-RL | Both | Both | Y | 1 | Cold start | Training | |
| Vanilla-DRL | N/A | N/A | Y | 1 | Cold-start | Training | |
| Hug-DRL | Y | Y | Y | 2 | Cold start | Training | Experiment B |
| | N | Y | Y | 2 | Cold start | Training | Experiment C |
| | Y | Y | Y | 2 | Cold start | Training | |
| | Y | N | Y | 2 | Cold start | Training | |
| Hug-DRL | Y | Y | N/A | 1 | Pre-trained | Training | Experiment D |
| IA-RL | Y | Y | N/A | 1 | Pre-trained | Training | |
| HI-RL | Y | Y | N/A | 1 | Pre-trained | Training | |
| Hug-DRL | Y | Y | Y | 1 | Cold start | Training | Experiment E |
| | Y | Y | N | 1 | Cold start | Training | |
| | Y | Y | Y | 0-3 | Cold start | Training | |
| Hug-DRL | N/A | N/A | N/A | N/A | N/A | Testing | Experiment F |
| IA-RL | N/A | N/A | N/A | N/A | N/A | Testing | |
| HI-RL | N/A | N/A | N/A | N/A | N/A | Testing | |
| Vanilla-DRL | N/A | N/A | N/A | N/A | N/A | Testing | |
| Vanilla-IL | N/A | N/A | N/A | N/A | N/A | Testing | |
| Dagger-IL | N/A | N/A | N/A | N/A | N/A | Testing | |

### Results

To investigate the feasibility and effectiveness of the proposed improved DRL with human guidance, a series of experiments with 40 human participants is conducted in the designed autonomous driving scenarios on a human-in-the-loop driving simulator 400. In total, there are six typical scenarios (i.e., Experiments A-F); one is for the training process of the proposed method (associated with Experiments A to E), and the other five are designed for testing and evaluating the performance of the designed algorithm, as illustrated in Experiment F. The training scenario considered a challenging driving task, i.e., continuous lane-changing and overtaking, where the reward from the environment encouraged non-collision and smooth driving behaviours. To successfully complete the designed tasks, in all scenarios, the ego vehicle is required to start from the spawn position, stay on the road, avoid any collision with any obstacles, and eventually reach the finishing line. If the ego vehicle collided with the road boundary or other traffic participants, the episode is immediately terminated and a new episode started with new spawned vehicles to continue the training process. The types, positions, and speeds of surrounding objects vary in the testing scenarios to improve the training performance of the policies under various situations with higher requirements.

To validate the improvement in the training performance, Experiment A is conducted by comparing the proposed method with other human guidance-based DRL approaches. First, all related baseline DRL algorithms were implemented with the same form of real-time human guidance for convenience during the comparison. More specifically, the three baseline DRL approaches are intervention-aided DRL (IA-RL), with fixed weighting factor ω_{I} for human guidance in the policy function of DR; human intervention DRL (HI-RL), with a shaped value function but without modification of the policy function; and the vanilla-DRL method (the standard TD3 algorithm without human guidance). All policy networks in these methods are pre-initialized by SL to enable faster convergence.

To investigate the effects of different human factors on the DRL training, Experiments B and C were conducted to address two key elements, i.e., human intervention mode and task proficiency, respectively. Experiment B is conducted to explore how different intervention modes, i.e., continuous mode 414 and intermittent mode 416, affected DRL training performance. The continuous mode 414 requires more frequent human supervision and intervention than the intermittent mode 416, and it allows human participants to disengage from the supervision loop for a while. The contrast is expected to reveal the impacts of human participation frequency on learning efficiency and subjective human fatigue. Subjects with higher proficiency or qualifications regarding a specific task are usually expected to generate better demonstrations. Experiment C is designed to investigate this expectation and to assess correlations between human task proficiency/qualifications and DRL performance improvement (i.e., 418 and 420).

Despite the pre-initialization, the above three experiments started with a train-from-scratch DRL agent, denoted “cold-start for initial training” (i.e., 410). However, in real-world applications such as automated driving, even if the DRL agent has been sufficiently trained beforehand, an online fine-tuning process is needed to further improve and ensure policy performance after deployment. Thus, Experiment D is designed to explore the varying effects and performance of the policies pre-trained under different algorithms throughout the fine-tuning process, as denoted by “pre-trained for fine-tuning” (i.e., 412). Here, “pre-trained” refers to the well-trained DRL policy rather than the pre-initialization conducted by SL.

Experiment E is an ablation investigation of the effect of pre-initialization and reward shaping on DRL performance.

The abovementioned experimental arrangements (Experiments A-E) demonstrate the superiority of the proposed method over other human guidance-based DRLs with respect to training efficiency and performance improvement. However, it is also necessary to test the performance of different policies in autonomous driving tasks under various scenarios. In addition, as imitation learning holds a great advantage in training efficiency due to non-interactive data generation, it is also useful to compare the performances of the IL and DRL paradigms in testing. Thus, in experiment F, the driving policies obtained from the proposed Hug-DRL, the selected DRL baseline methods, and the IL methods (i.e., vanilla-IL and DAgger) are compared as illustrated by 422.

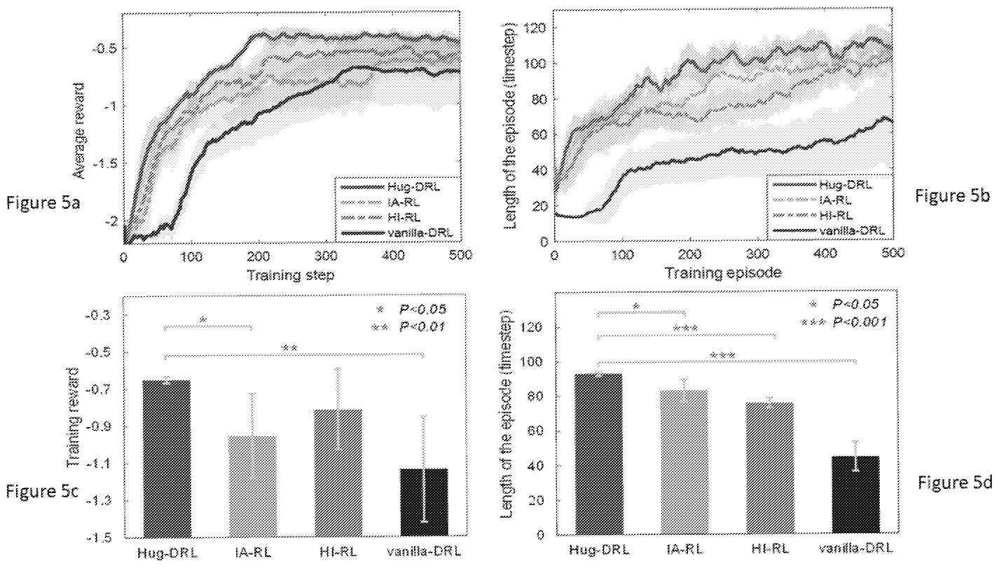

FIGS. 5a-5d illustrate the improved training performance of the proposed Hug-DRL method. In particular, FIGS. 5a-5d show the results of the initial training performance under four different methods. FIG. 5a illustrates results of the episodic training reward under different methods. The mean and SD values of the episodic training reward are calculated based on the values of the obtained rewards per episode across all subjects under each method. FIG. 5b illustrates results of the episodic length under the three methods. The mean and SD values of the episodic step length are calculated based on the values of the episodic length achieved per episode across all subjects under each method. FIG. 5c shows results of the average reward during an entire training session under different methods. The statistical values of the training reward are calculated based on the average value of the obtained rewards during the overall training process across all subjects under each method. FIG. 5d shows results of the average episodic length during the entire training session under different methods. The statistical values of the episodic length are calculated based on the average value of the achieved episodic length during the overall training process across all subjects under each method.

The results shown in FIGS. 5a-5d, which are obtained from Experiment A, validate the performance improvement brought by the proposed Hug-DRL method compared to other state-of-the-art human guidance-based algorithms, IA-RL, HI-RL, and vanilla-DRL without human guidance (a pure TD3 algorithm). During the experiments, the time step reward and duration of each episode are recorded and assessed for each participant in order to evaluate the training performance throughout an entire training session under each method. Both the episodic reward and the length of the episode are evaluated, as reflected in FIGS. 5a and 5b. The results indicated that the Hug-DRL method is advantageous over all other baseline methods with respect to asymptotic rewards and training efficiency. The statistical results shown in FIG. 5c show that the average reward obtained with the proposed method during the entire training process is the highest (M=−0.649, SD=0.036), followed by that obtained with the HI-RL method (M=−0.813, SD=0.434), the IA-RL method (M=−0.954, SD=0.456) and then the vanilla-DRL method (M=−1.139, SD=0.567).

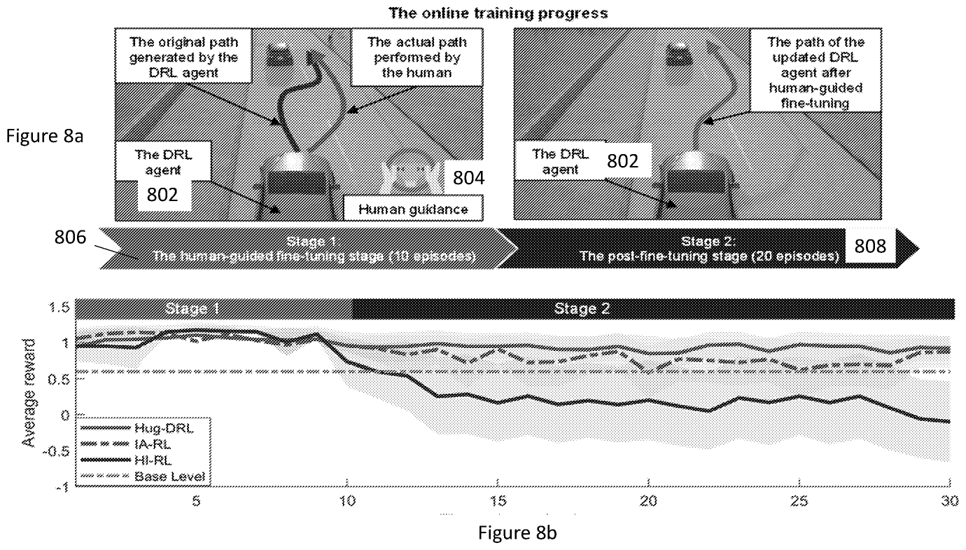

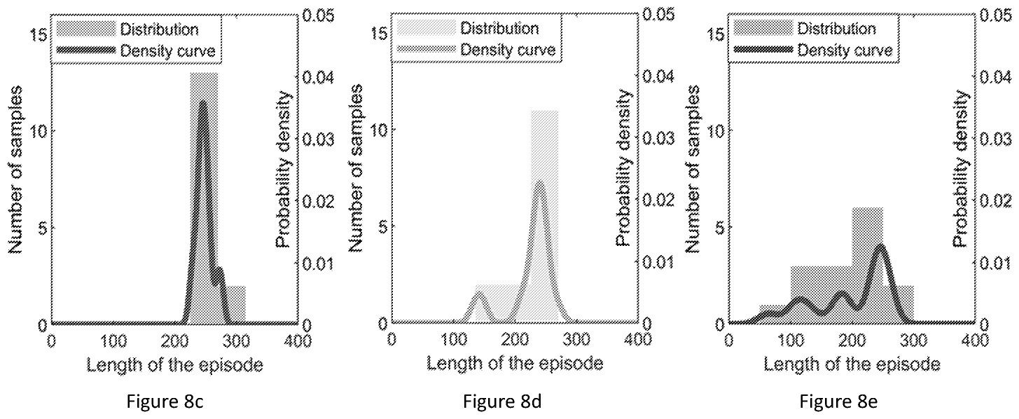

Additionally, the differences between the methods are tested according to the one-way ANOVA presented in Table 4, while illustrates ANOVA for the training reward of different DRL methods with the “cold-start” condition. Significant values at the α=0.05 level are marked bold. The length of the episode, which accurately described task-completion ability, is also compared for the three methods. Based on the results shown in FIG. 8d, the mean value of the proposed method (M=93.1, SD=2.4) is advantageous over that of the IA-RL method (M=83.2, SD=12.7), the HI-RL method (M=75.8, SD=5.5) and the vanilla-DRL method (M=44.3, SD=16.8). Their differences are statistically significant, F(4.36)=36.91, as reflected by the ANOVA presented in Table 5, which illustrates ANOVA for the averaged length in timestep of different DRL methods with the “cold-start” condition. Significant values at the α=0.05 level are marked bold. In terms of asymptotic rewards, compared to vanilla-DRL, the performance improvements under Hug-DRL, IA-RL and HI-RL are 34.4%, 10.1%, and 20.9%, respectively. The above results demonstrate the effectiveness of human guidance in improving DRL performance.

TABLE 4
Metric 1: ANOVA Table

| Source | Sum Sq. | d.f | Mean Sq. | F-value | p-value |
|---|---|---|---|---|---|
| between-groups | 1.30 | 3 | 0.43 | 2.41 | 0.083 |
| variation | | | | | |
| within-groups | 6.47 | 36 | 0.18 | | |
| variation | | | | | |
| Total | 7.77 | 39 | | | |

Metric 2: Multiple comparisons between groups

| | Difference between | |
|---|---|---|
| Compared pair | estimated group means | p-value |
| Proposed Hug-DRL | 0.16 | 0.25 |
| vs. HI-RL | | |
| Proposed Hug-DRL | 0.30 | 0.049 |
| vs. IA-RL | | |
| Proposed Hug-DRL | 0.49 | 0.014 |
| vs. Vanilla-DRL | | |

TABLE 5
Metric 1: ANOVA Table

| Source | Sum Sq. | d.f. | Mean Sq. | F-value | p-value |
|---|---|---|---|---|---|
| between-groups | 13309.1 | 3 | 4436.38 | 36.91 | 4.45e−11 |
| variation | | | | | |
| within-groups | 4327.5 | 36 | 120.21 | | |
| variation | | | | | |
| Total | 17636.6 | 39 | | | |

Metric 2: Multiple comparisons between groups

| | Difference between | |
|---|---|---|
| Compared pair | estimated group means | p-value |
| Proposed Hug-DRL | 9.90 | 0.027 |
| vs. IA-RL | | |
| Proposed Hug-DRL | 17.26 | 3.89e−8 |
| vs. HI-RL | | |
| Proposed Hug-DRL | 48.73 | 3.94e−8 |
| vs. Vanilla-DRL | | |

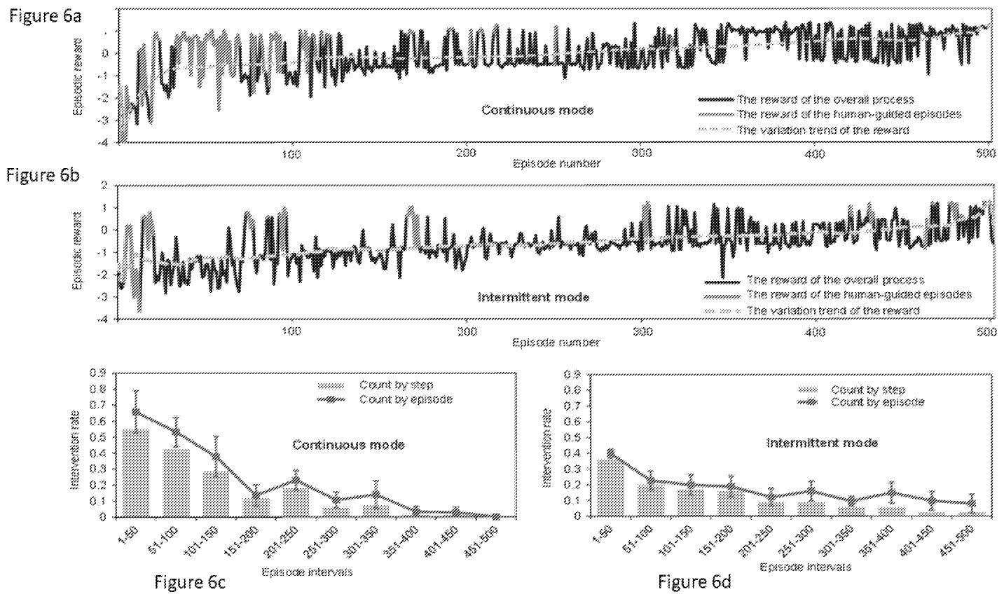

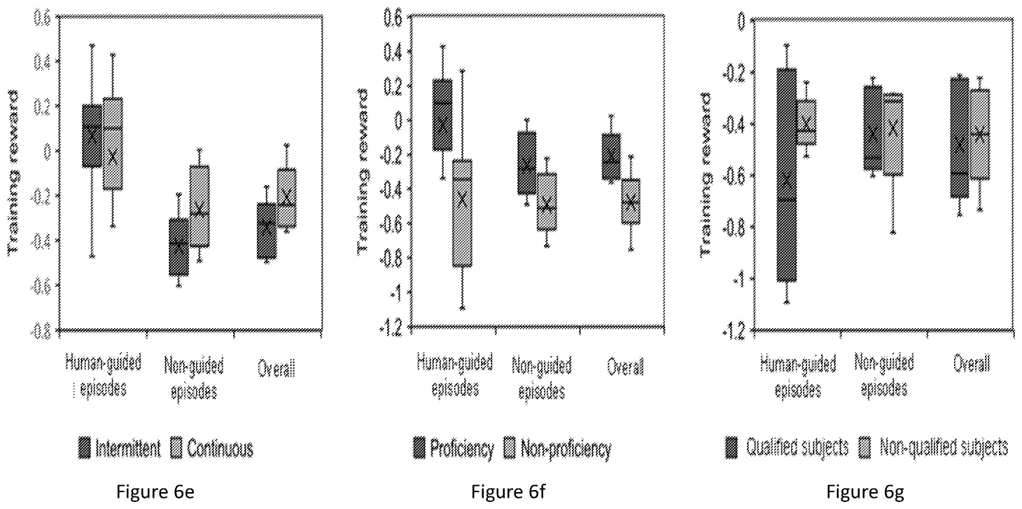

Also important to assess the efficacy of present methods are the effects of different human guidance modes on training performance. FIGS. 6a-6g illustrate the results of the impacts of human factors on DRL training performance. FIG. 6a shows example data of the episodic rewards over the entire training session for the continuous guidance mode obtained by a representative subject. The human-guided episodes are mainly distributed in the first half of the training process, and the guidance actions are relatively continuous.

FIG. 6b shows example data of the episodic reward over the entire training session for the intermittent guidance mode obtained by a representative subject. The human-guided episodes are sparsely distributed throughout the entire training session.

FIG. 6c shows the human intervention rates during the entire training sessions for the continuous guidance mode. Here, two indicators, namely the one ‘count by step’ and the other one ‘count by episode’, are adopted to evaluate the human intervention rate. The former one is calculated based on the total number of steps guided by a human in a specific episodic interval, whereas the latter one is calculated based on the number of episodes intervened by a human.

FIG. 6d shows the human intervention rates during the entire training sessions for the intermittent guidance mode.

FIG. 6e shows box plots of the training rewards achieved under the intermittent and continuous guidance modes. Under each mode, the training rewards are further analysed based on the human-guided episodes, non-guided episodes, as well as the entire process, separately.

FIG. 6f shows box plots of the training rewards achieved under the guidance provided by proficient and non-proficient participants.

FIG. 6g illustrates box plots of the training rewards achieved under the guidance provided by qualified and unqualified participants.

Two groups of tests were conducted, requiring each human subject to participate in the DRL training using intermittent and continuous intervention modes. Example data on the episodic rewards throughout the training session for the continuous and intermittent guidance modes obtained from a representative participant are shown in FIGS. 6a and 6b. The results show that both the continuous and intermittent modes led to a consistently increasing trend for the episodic reward during training. Although the episodic reward increased earlier in the former mode as the human intervened more frequently in the initial training phase, the final rewards achieved are at the same level for both modes. The human intervention rates during the entire training session for the continuous and intermittent guidance modes are further investigated, as shown in FIGS. 6c and 6d. The mean values of the intervention rates (count by step) across participants for the continuous and intermittent modes are M=25, SD=8.3 (%) and M=14.9, SD=2.8 (%), respectively. Moreover, one training process was split into three separate sections, namely, the human-guided section, the non-guided section, and the overall section, and the achieved rewards are examined for each section in detail for the two intervention modes separately. As illustrated in FIG. 6e, within the human intervention sections, the mean values of the training rewards for continuous and intermittent modes are M=−0.03, SD=0.41 and M=0.07, SD=0.25, respectively, but no significant difference is found between the two (p=0.85). Similarly, for the non-intervention sections, although the average reward of the continuous mode (M=−0.26, SD=0.18) is higher than that of the intermittent mode (M=−0.42, SD=0.14), no significant difference is found (p=0.064). The above results indicated that in terms of the final DRL performance improvement, there is no significant difference between the continuous and intermittent modes of human guidance.

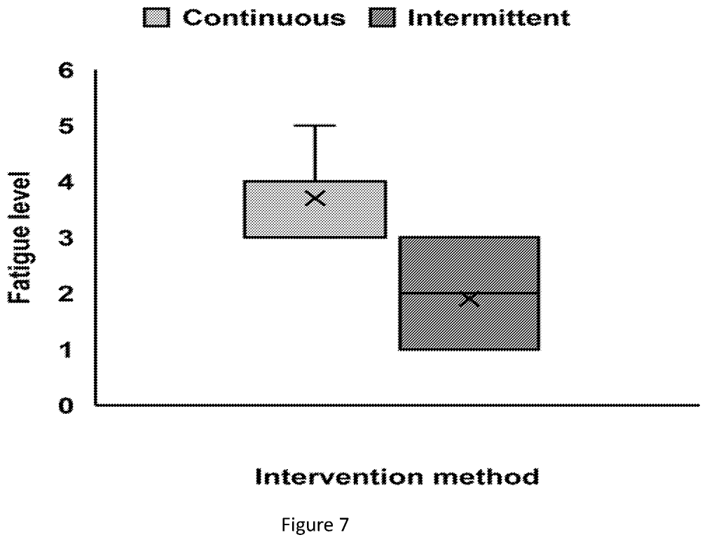

However, from the perspective of human workload, the intermittent mode is advantageous over the continuous mode, according to our subjective survey administered to participants (see FIG. 7 and Table 6). FIG. 7 illustrates evaluation of the subjective responses to the question on workload during experiments. The human workload levels under the continuous and intermittent guidance modes are rated at 3.70±0.67, and 1.90±0.88, respectively (rating scale from 1: very low, to 3: normal, to 5: very high). A significant difference between the two groups is found (p<0.001). The utilized data of this figure is listed in Table 6, which illustrates the subjective evaluation scores of participants under the two guidance modes. Significant value at the α=0.05 level is marked bold.

TABLE 6

| | | | Subjective scores regarding workload | |
|---|---|---|---|---|
| Participant information | | | (1: very low, 5: very high) | |
| Index | Sex | Age | Continuous mode | Intermittent mode |
| 1 | Male | 26 | 3 | 1 |
| 2 | Male | 32 | 5 | 3 |
| 3 | Male | 28 | 4 | 3 |
| 4 | Male | 24 | 3 | 2 |
| 5 | Male | 29 | 4 | 2 |
| 6 | Male | 27 | 3 | 1 |
| 7 | Male | 33 | 3 | 1 |
| 8 | Male | 30 | 4 | 3 |
| 9 | Female | 33 | 4 | 2 |
| 10 | Female | 30 | 4 | 1 |

| Mean | 3.7 | 1.9 |
|---|---|---|
| S.D. | 0.67 | 0.88 |
| p-value of paired t-test | 6.74e−5 | |
| between the two modes | | |

The effects of human proficiency/qualifications on training performance was then investigated. Task proficiency or qualifications are other human factors that may have affected DRL training performance under human guidance. Experiment C is conducted to examine the correlations between the improvement of DRL performance and task proficiency/qualifications. As shown in FIGS. 6f and 6g, the agent training rewards achieved by proficient/non-proficient and qualified/unqualified participants are illustrated and compared. In the intervention sections, proficient participants guided the DRL agent to gain a higher reward (M=−0.03, SD=0.41) than non-proficient participants (M=−0.46, SD=0.42).

For the non-intervention sections, the values of the average rewards under the guidance of proficient and non-proficient subjects are M=−0.26, SD=0.18 and M=−0.49, SD=0.18, respectively. In the overall training sessions, although there is a slight difference between the two groups with respect to the training reward, i.e., M=−0.21, SD=0.14 for the proficient group and M=−0.48, SD=0.17 for the non-proficient group, no significant difference is found between the two based on a within-group comparison (p=0.11). Tables 7 and 8 present a non-parametric ANOVA of performance resulting from the standard DRL method and proficient/non-proficient participants of the proposed Hug-DRL method. Table 7 illustrates Kruskal-Wallis ANOVA for the training rewards obtained in the non-guided sections during the “cold-start” training by the proposed Hug-DRL method with proficient and non-proficient participants. The standard DRL approach is taken as the baseline for comparison. Significant values at the α=0.05 level are marked bold. Table 8 shows Kruskal-Wallis ANOVA for the overall training reward obtained in the “cold-start” training by the proposed Hug-DRL method with proficient and non-proficient participants. The standard DRL approach is taken as the baseline for comparison. Significant values at the α=0.05 level are denoted with boldface type. In addition, no significant difference is found between the results of qualified and unqualified participants. The above comparison results indicated that the proposed real-time human guidance-based method had no specific requirement for task proficiency, experience, or qualifications of the participating human subjects.

TABLE 7
Metric 1: ANOVA Table

| Source | Sum Sq. | d.f. | Mean Sq. | F-value | p-value |
|---|---|---|---|---|---|
| Between-groups | 1680.00 | 2 | 840.00 | 21.68 | 1.96e−5 |
| variation | | | | | |
| Within-groups | 567.50 | 27 | 21.02 | | |
| variation | | | | | |
| Total | 2247.50 | 29 | | | |

Metric 2: Multiple comparisons between groups

| | Difference between | |
|---|---|---|
| Compared pair | estimated group means | p-value |
| Proficient Hug-DRL | 6 | 0.28 |
| vs. Non-proficient | | |
| Hug-DRL | | |
| Proficient Hug-DRL | 18 | 1.44e−5 |
| vs. Standard DRL | | |
| Non-proficient | 12 | 0.0065 |
| Hug-DRL vs. | | |
| Standard DRL | | |

TABLE 8
Metric 1: ANOVA Table

| Source | Sum Sq. | d.f. | Mean Sq. | F-value | p-value |
|---|---|---|---|---|---|
| Between-groups | 1680.00 | 2 | 840.00 | 21.68 | 1.96e−5 |
| variation | | | | | |
| Within-groups | 567.50 | 27 | 21.02 | | |
| variation | | | | | |
| Total | 2247.50 | 29 | | | |

Metric 2: Multiple comparisons between groups

| | Difference between | |
|---|---|---|
| Compared pair | estimated group means | p-value |
| Proficient Hug-DRL | 6 | 0.28 |
| vs. Non-proficient | | |
| Hug-DRL | | |
| Proficient Hug-DRL | 18 | 1.44e−5 |
| vs. Standard DRL | | |
| Non-proficient | 12 | 0.0065 |
| Hug-DRL vs. | | |
| Standard DRL | | |

The present disclosure now discusses the improved online fine-tuning performance of the Hug-DRL. FIGS. 8a-8e illustrate the results of the online training performance of the DRL agent 802 under the human guidance 804 under the proposed method. FIG. 8a illustrates schematic diagram of the agent performance during the online training progress under the proposed Hug-DRL method. The original path is generated by the DRL agent 802, and the actual path is performed according to the human guidance 804. The path of the updated DRL agent 802 is then performed after the human-guided fine-tuning. The entire online training progress is divided into two stages, namely stage 1 (i.e., 806): the 10-episode human-guided fine-tuning stage, and stage 2 (i.e., 808): the 20-episode non-guided post-fine-tuning stage. During fine-tuning, some undesirable actions of the agent 802 are further optimized by human guidance 804. As a result, the performance of the DRL agent 802 is further improved, which is reflected by the generated smooth path in the post-fine-tuning stage 808.

FIG. 8b illustrates the results of the episodic reward during the online training process under the proposed and two baseline approaches. Before fine-tuning, the DRL agent is pre-trained in the training scenario 0, and the average reward achieved after the pre-training session is set as the base level for comparison in the fine-tuning stage.

FIG. 8c illustrates the distribution of the episodic length obtained under the proposed Hug-DRL method across participants during the post-fine-tuning stage.

FIG. 8d illustrates the distribution of the episodic duration obtained under the baseline IA-RL method across participants during the post-fine-tuning stage.

FIG. 8e shows the distribution of the episodic duration obtained under the baseline HI-RL method across participants during the post-fine-tuning stage.

As validated by the above exploration, the proposed real-time human guidance approach is capable of effectively improving DRL performance with the initial condition of a “cold-start”. Subsequently, it is very interesting to conduct Experiment D to explore the online fine-tuning ability of the proposed method, which would further improve the agent's performance. As the representative examples show in FIG. 8a, in the experiments, the participants are asked to provide guidance whenever they felt it is necessary within the first 10 training episodes of fine-tuning, helping the agent that originally performed at the base level to further optimize the driving policy online. Afterward, the DRL agent continued the remaining 20 episodes until the end of the online training session.

In this experiment, the proposed Hug-DRL method is compared to the other two human guidance-based approaches, namely, IA-RL and HI-RL. Based on the performance shown in FIG. 8b, in the fine-tuning stage, the proposed method and the baseline methods achieved similar episodic rewards (the proposed method: M=1.02, SD=0.36; IA-RL: M=1.06, SD=0.08, HI-RL: M=1.03, SD=0.10). However, in the session after human-guided fine-tuning, the average reward of the proposed method (M=0.92, SD=0.35) is higher than that of IA-RL (M=0.76, SD=0.50) and much higher than that of HI-RL (M=0.19, SD=1.01).

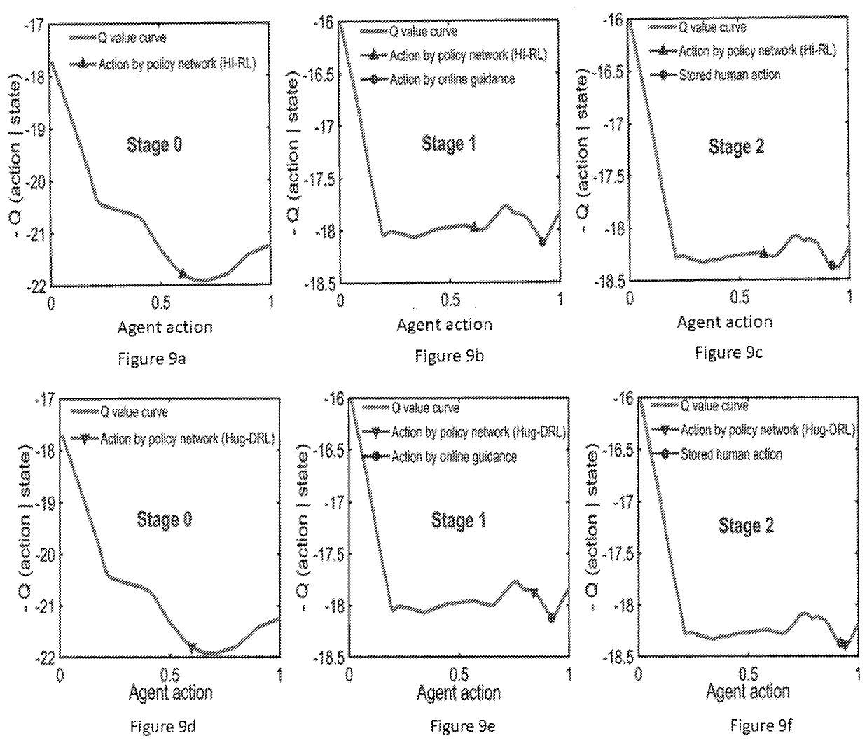

The results shown in FIGS. 8c and 8e show that the distribution of the episodic length obtained after fine-tuning under the proposed Hug-DRL method is more concentrated than that under the two baseline methods. The mechanism for the better performance of Hug-DRL and IA-RL compared to that of HI-RL after fine-tuning is also analysed, as illustrated in FIGS. 9a-9f. In short, although the evaluation curve of the value network is updated by the human guidance action during fine-tuning, the policy network of HI-RL fell into the local optima trap during the post-fine-tuning stage, failing to converge to the global optima (see FIGS. 9a to 9c). Hug-DRL and IA-RL could successfully solve this issue (see FIGS. 9d to 9f), and Hug-DRL achieved better performance than IA-RL. Overall, the above results indicated that the proposed method had a higher ability to fine-tune the DRL agent online than the other state-of-the-art human guidance-based DRL methods.

In particular, FIGS. 9a-9f shows illustration of the finetuning stage of the Hug-DRL and HI-RL methods. The data is collected from one timestep of a typical participant's experimental results, where the input state and human-guidance action are kept the same in two methods for comparison. The horizontal axis represents all possible actions of the agent, which is the steering wheel angle in this work. [0, 1] corresponds to the entire range of the steering wheel angle from the extreme left position to the extreme right position.

FIG. 9a illustrates action evaluation by the value network of the pre-trained HI-RL agent at stage 0 (before fine-tuning). At stage 0: before fine-tuning, the actions given by the policy network of HI-RL agent are away from the optimal solution evaluated by the value network.

FIG. 9b illustrates action evaluation by the value network of HI-RL during stage 1 (the fine-tuning stage). The evaluation curve of the value network is updated based on the guidance action provided by the human participant, resulting in a new global optimal solution. Yet, the update of the HI-RL's policy network remained unremarkable.

FIG. 9c illustrates action evaluation by the value network of the HI-RL during stage 2 (the post-fine-tuning stage). After the fine-tuning, the policy network of the HI-RL failed to reach the global optimal point, as the agent fell into the local optima trap resulted from the gradient-descent update principle.

FIG. 9d illustrates action evaluation by the Hug-DRL agent at stage 0. The actions given by the policy network are also away from the optimal solution evaluated by the value network.

FIG. 9e shows action evaluation by the Hug-DRL at stage 1. The evaluation curve of the value network is updated based on the guidance action provided by the human participant and generated a new global optimal solution similar to the situation of HI-RL. The policy network of the Hug-DRL is able to approach the new optima thanks to the redesigned policy function in the proposed method.

FIG. 9f illustrates action evaluation by the value network of the Hug-DRL at stage 2. The policy network of the Hug-DRL maintained a good performance and avoided the local optima trap during the post-fine-tuning stage.

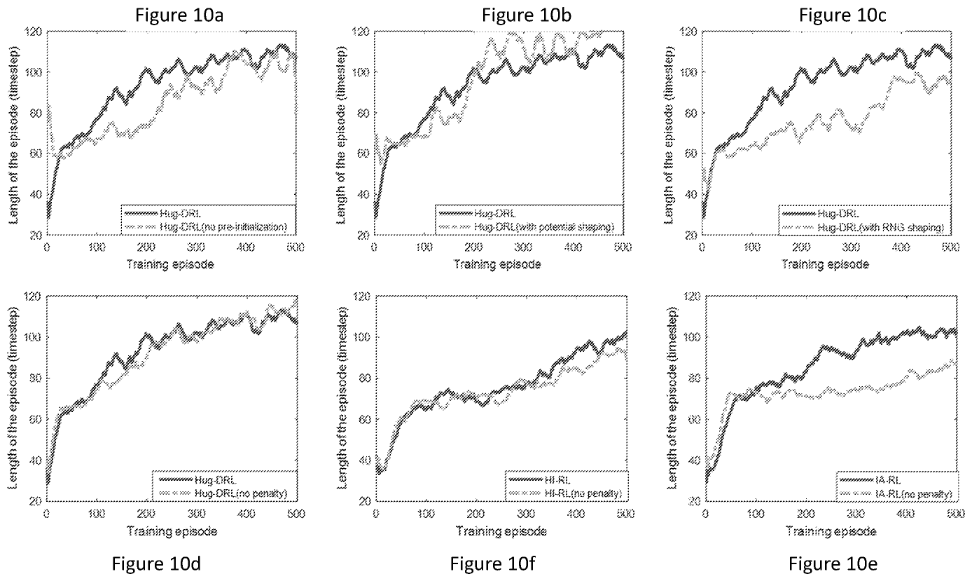

The autonomous driving policy trained by Hug-DRL under various scenarios was then tested. To construct and optimize the configuration of the DRL-based policy, an ablation test is carried out in Experiment E to analyse the significance of the pre-initialization and reward-shaping techniques. According to the results shown in FIG. 10a, removal of the pre-initialization process deteriorates the training performance of the DRL agent (length of episode: M=93.1, SD=2.44 for the pre-initialization scheme, M=84.8, SD=4.8 for the no-initialization scheme, p<0.001). Moreover, different reward-shaping mechanisms had varying effects on performance, based on the results in FIGS. 10b-10f.

In particular, FIGS. 10a-10f illustrate the results of the ablation investigation on pre-initialization and reward shaping. FIG. 10a illustrates the length of the episode (counted by time step of the simulator) of Hug-DRL during the training session obtained with/without the pre-initialization. FIG. 10b illustrates the length of the episode of Hug-DRL during the training session obtained with/without the potential-based reward shaping, i.e., the shaping technique 2. FIG. 10c illustrates the length of the episode of Hug-DRL during the training session obtained with/without the RNG reward shaping, i.e., the shaping technique 3. FIG. 10d illustrates the length of the episode of Hug-DRL during the training session obtained with/without the intervention penalty-based reward shaping, i.e., the shaping technique 1. FIG. 10e illustrates the length of the episode of HI-RL during the training session obtained with/without the intervention penalty-based reward shaping. FIG. 10f shows the length of the episode of IA-RL during the training session obtained with/without the intervention penalty-based reward shaping.

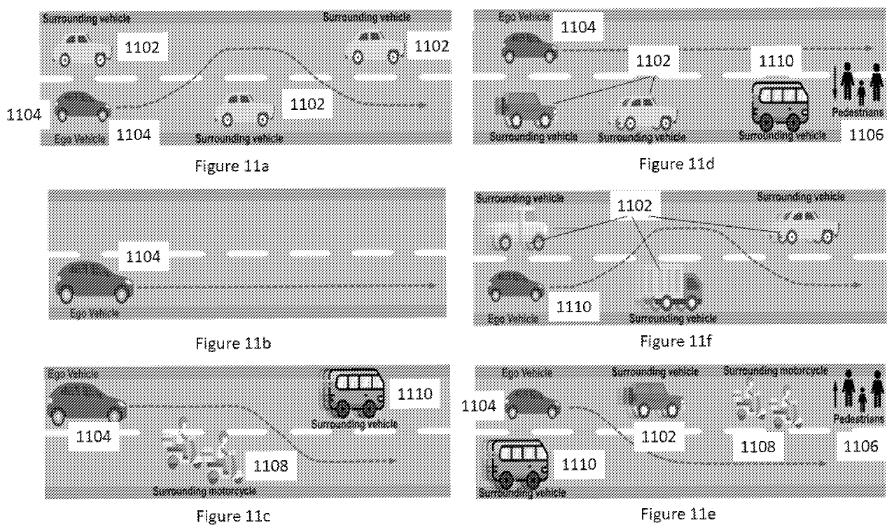

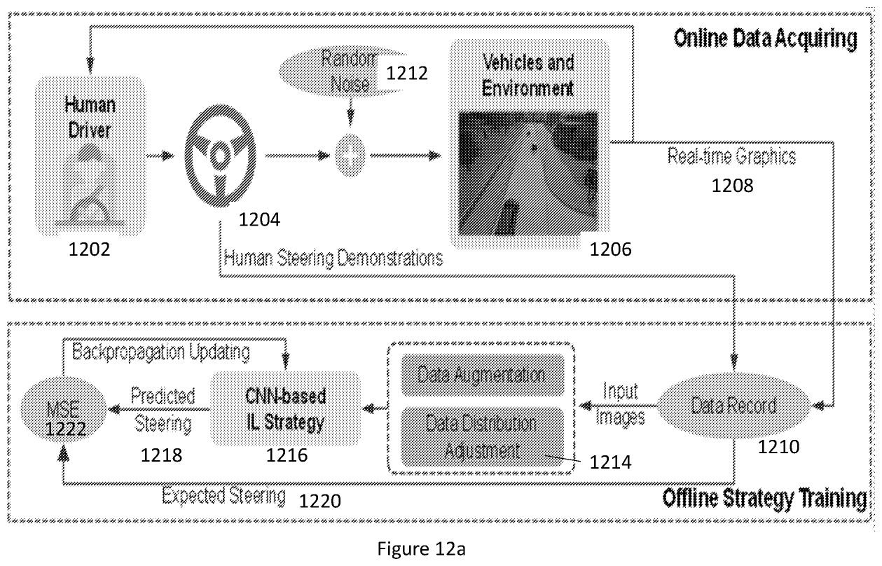

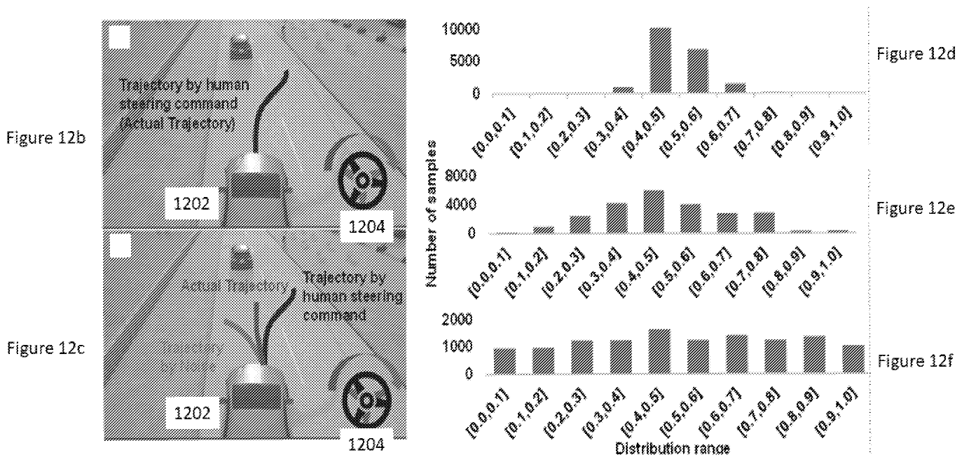

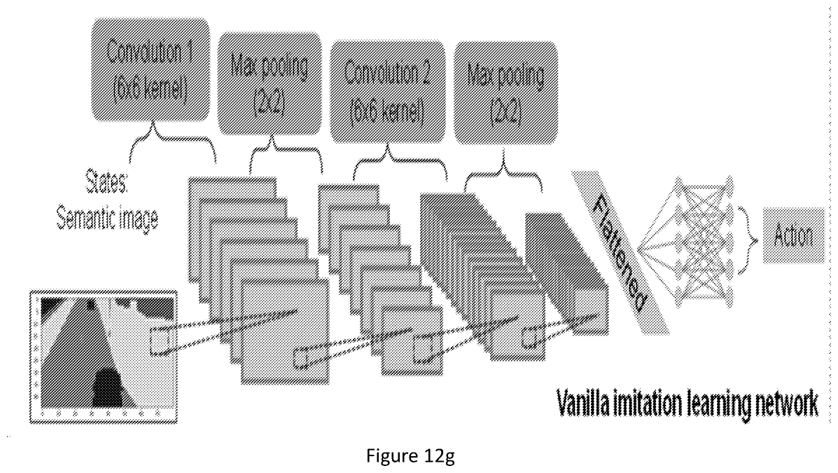

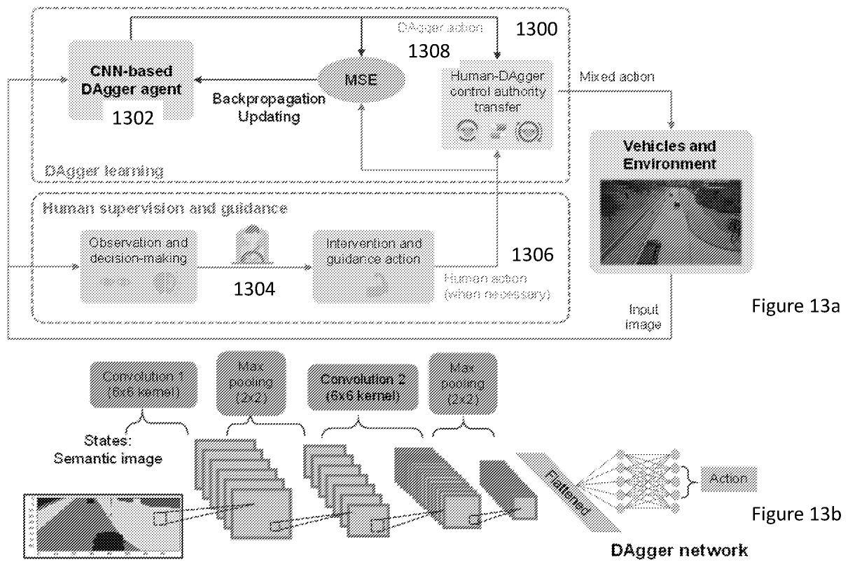

Finally, to further validate feasibility and effectiveness, in Experiment F, the trained model for the proposed method is tested in various autonomous driving scenarios (introduced in FIG. 11 in detail) and compared with five other baseline methods, i.e., IA-RL, HI-RL, vanilla-DRL, vanilla imitation learning (vanilla-IL) (see FIG. 12), and DAgger (see FIG. 13). Various testing scenarios are designed to examine the abilities of the learned policy, including environmental understanding and generalization.

FIGS. 11a-11f show schematic diagram of the scenarios for training and testing of the autonomous driving agent 1104. FIG. 11a shows a Scenario 0 which serves as a simple situation with all surrounding vehicles 1102 being set as stationary states. It is utilized only for the training stage. Besides, two pedestrians are spawned at random positions in some episodes, but are not shown in the figure due to the unfixability.

FIG. 11b shows a Scenario 1 which is used to test the steady driving performance of the agent 1104 on the freeway, with the removal of all surrounding traffic participants. It is used to evaluate the anti-overfitting performance of the generated driving policy.

FIGS. 11c-11f show Scenarios 2 to 5 used to test the adaptivity of the obtained policy in unseen situations shielded from the training stage. The moving pedestrians 1106, motorcycles 1108, and buses 1110 are added into the traffic scenarios. Since the interactive relationships between the ego vehicle on which the agent 1104 is installed and the traffic participants are changed, the expected trajectories of the ego vehicle should be different from those in the training process. These are set to evaluate the scene understanding ability and its adaptivity and robustness of the autonomous driving agent 1104.

FIGS. 12a-12e show implementation details of the vanilla imitation learning-based strategy for autonomous driving. FIG. 12a illustrates the architecture of the vanilla-IL-based method. Human participants 1202 provide real-time control input through the steering wheel 1204 as demonstrations in the simulated driving environment 1206, where corresponding images 1208 and control commands (not shown) are recorded for subsequent training. The obtained data 1210 are firstly processed with augmentation and adjustment (see 1214) and are subsequently used for the training of the convolutional neural network 1216. The convolutional neural network 1216 outputs the predicted steering commands 1218. The expected steering commands 1220 are retrieved from recorded data 1210. The mean squared error (MSE) 1222 between predicted steering commands 1218 and expected steering commands 1220 is used to train the convolutional neural network 1216 through the backpropagation method. The Gaussian noise signal 1212 is injected into the original output of the steering wheel angle to generate many demonstration scenes.

FIG. 12b illustrates the schematic diagram of the conventional data sampling of the human participant. FIG. 12c shows the schematic diagram of the augmented data sampling of the human participant under injected noise. The recorded actions are only human actions, while the noise is filtered in the samples. FIGS. 12d-12f show the performance of demonstrated data augmentation and related adjustment. FIG. 12d shows the human demonstrated action sets without added noise. FIG. 12e shows the action distribution after noise-based augmentation, and FIG. 12f is the distribution histogram further processed by data augmentation and adjustment, which is the adopted training data in the imitation learning. FIG. 12g shows the architecture and parameters of the convolutional neural network in the vanilla-IL-based method, where input variables are kept the same as those in the DRL for comparison.

FIGS. 13a-13b show implementation details of the DAgger imitation learning-based strategy 1300 for autonomous driving. FIG. 13a shows the architecture of the DAgger IL-based method. Human participants 1304 perform driving control behaviors 1306 at the initial stage whereas the DAgger agent 1302 learns from the demonstration data. The control authority of the agent 1302 during training was mostly dominated by the DAgger. The human participants 1304 are required to intervene and adjust those risky actions given by the DAgger especially when the distributional shift problems occur. The method may therefore comprise identifying distributional shift and triggering (e.g. by audial or visual alert) correction or override from the human. The human demonstration data would be utilized for the further training of the DAgger agent 1302 by minimizing the loss between the DAgger actions 1308 and human actions 1306. FIG. 13b shows the architecture and parameters of the convolutional neural network in the DAgger-based method. The input variables are kept the same as those in the DRL for comparison.

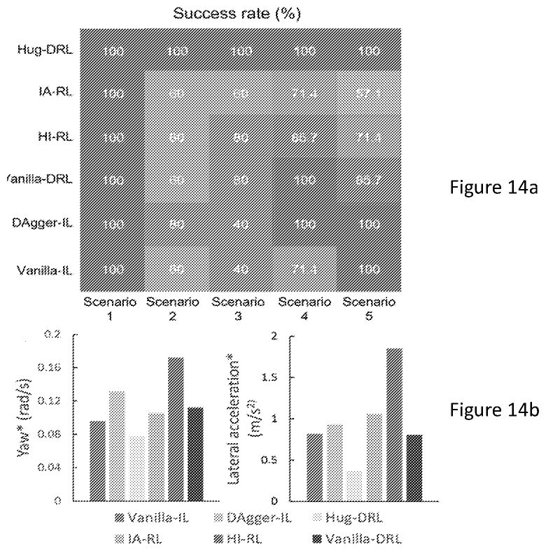

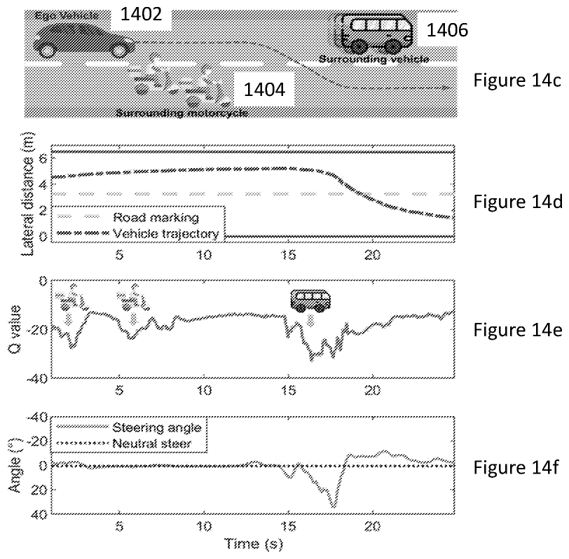

FIGS. 14a-14f illustrate results of the agent's performance under various driving scenarios. The agent's policy is trained by the six methods, separately. And the five scenarios, i.e., Scenarios 1 to 5, are unavailable in the training process and only used for the performance testing. FIG. 14a shows the success rates of the agent trained by different methods across the five testing scenarios, where the ego vehicle is spawned in different positions to calculate the success rate in one scenario.

FIG. 14b shows the plots of the mean of the agent's indicators under different scenarios, where two indicators: the mean of the absolute value of the yaw rate, and the mean of the absolute value of the lateral acceleration are recorded as indicators.

FIGS. 14c-14f shows illustration of a representative testing scenario with an agent which is trained beforehand by using the Hug-DRL. In the testing scenario, the agent 1402 is required to surpass two motorcycles 1404 and a bus 1406 successively. FIG. 14c shows the schematic diagram of the testing scenario; FIG. 14d shows the lateral position of the ego vehicle 1402. FIG. 14e shows the averaged Q value of the DRL agent. The value declined when the DRL agent approached the surrounding obstacles. FIG. 14f shows the variation of the control action, i.e., the steering wheel angle of the DRL agent. The negative values represent left steering and the positive values correspond to the right steering actions.

The success rate of task completion and the vehicle dynamic states (i.e., the yaw rate and lateral acceleration) are selected as evaluation parameters to assess the control performance of the autonomous driving agent. The heat map shown in FIG. 14a shows that the agent trained by Hug-DRL successfully completed tasks in all untrained scenarios, while agents under all baseline methods could complete only parts of the testing scenarios. Specifically, the success rates of the baseline methods are 84.6% for vanilla-DRL and DAgger, 76.9% for HI-RL, 73.1% for vanilla-IL, and 65.3% for IA-RL. In addition, the yaw rate and lateral acceleration of the agent for each method under scenario 1 are recorded and assessed, as shown in FIG. 14b. Hug-DRL led to the smoothest driving behaviour, with an acceleration of 0.37 m/s², and HI-RL resulted in the most unstable driving behaviour (1.85 m/s²). The performances of the other baseline methods are roughly similar.

In addition to performing the above investigations, it is of interest to explore the decision-making mechanism of Hug-DRL. One representative example of a testing scenario with a trained Hug-DRL agent is shown in FIGS. 14c-14f, which provide a schematic diagram of the scenario, the lateral position of the ego vehicle over time, the values given the current state and action, and the action of the agent. As shown in FIGS. 14c-14f, approaching two motorcycles would cause a two-fold decrease in the Q value in the current state if the current action is maintained, indicating higher potential risk. Correspondingly, the ego agent 1402 would change its action to avoid the objects and drive slightly to the left. Subsequently, the collision risk with the front bus 1406 increased, as reflected by the remarkably decreased Q value, and the DRL agent promptly decided to change lanes. These results show the effects of varying surrounding traffic participants on the decision-making process of the DRL agent 1402, and the intention and reasonable actions of the agent 1402 are reflected by the results of the value evaluation function.

The existing training process of DRL-based policy is very time-consuming and demands many computing resources, especially when dealing with complex tasks with high-dimensional data for scene representation. To address these limitations and further improve DRL algorithms by leveraging human intelligence, a novel human-in-the-loop DRL framework with human real-time guidance is proposed and investigated from different perspectives. In addition to the proposed Hug-DRL approach, two baseline methods with different real-time human guidance mechanisms are implemented and compared, as are non-human-involved algorithms. As reflected by the results shown in FIGS. 5a-5d, all human-involved DRL methods are advantageous over the vanilla-DRL method in terms of training efficiency and reward achieved, demonstrating the necessity and significance of real-time human supervision and guidance in the initial training stage.

For actor-critic DRL algorithms, actions are determined by the policy function, where the update optimizes the value function, as expressed in Eq. (6). Thus, the updating rate of the policy network is constrained by the convergence rate of the value function, which relies on a relatively low-efficiency exploration mechanism. However, from the perspective of human beings who hold prior knowledge and a better understanding of the situation and the required task, this learning is clumsy because the agent has to experience numerous failures during explorations before gradually reaching feasible solutions. This constitutes the “cold-start” problem. However, in all human-involved DRL methods, random and unreasonable actions are replaced by appropriate human guidance actions. Consequently, there are more reasonable combinations of states and actions being fed to the value network, effectively improving the distribution of the value function and its convergence towards the optimal point in a shorter time. Therefore, the updating of the value network becomes more efficient, which accelerates the entire training process.

With regard to the three human-involved DRL approaches, the proposed Hug-DRL approach achieves the best training efficacy and asymptotic performance; IA-RL performs second best, and HI-RL performs the worst. The underlying reason for these results is the human guidance term of Hug-DRL and IA-RL (Eq. (8)). Specifically, in addition to the action replacement scheme in HI-RL, the human guidance term directly encourages the policy network to output human-like actions, accelerating the value function's evaluation of acceptable policies. The subsequent problem becomes how to balance human guidance and the policy gradient-based updating principle. The competing methods either shield the gradient term whenever human beings provide guidance or pre-set a fixed ratio between two terms. These methods fail to consider the effect of different human participants and the ever-improving ability of the DRL agent. In the proposed Hug-DRL method, the weighting assignment mechanism adaptively adjusts the dynamic trustworthiness of the DRL policy against different human guidance in the training process. In comparison to the stiff conversion mechanism of the IA-RL baseline method, Hug-DRL leverages human experience more reasonably and scores higher, as shown in FIGS. 5a-5d.

In addition to demonstrating performance improvement during the training-from-scratch process, Hug-DRL proved beneficial with respect to its online fine-tuning ability. For learning-based approaches, including DRL, even if the models are well trained, their performance is compromised in real-world implementations due to unpredictable and uncertain environments. Thus, an online fine-tuning process after deployment is of great importance for DRL applications in the real world. The fine-tuning performance was evaluated for all three methods involving human guidance, i.e., Hug-DRL, IA-RL, and HI-RL. As shown in the subplots of FIGS. 8b-8e, the performance improvement of HI-RL vanished throughout the fine-tuning. However, our approach successfully maintained the improved performance throughout the post-fine-tuning phase, indicating its higher ability. This phenomenon may be explained by the consistency of the updates between the policy and value networks under human guidance. For the HI-RL model that receives human guidance, its policy network is updated according to the objective function with {s, μ(s|Θ^{μ})} in Eq. (6). However, the value network is constructed according to {s, a^{human}} expressed by Eq. (7). Generally, a human guidance action generates a higher true value, but it is not correctly evaluated by the value network before fine-tuning. As online fine-tuning progresses, the value network realizes the deficiency and gradually updates its output. However, sometimes the policy function struggles to catch up with the pace of the policy network's update. This means that even if the policy network has already converged towards a local optimum in the initial training phase, the change of a single point on the value function distribution that benefited from human guidance does not optimize the gradient descent-based policy function. Accordingly, the policy still updates the function around the original local optima and thus fails to further improve itself in the expected direction. The inconsistency between the policy and value networks can be observed from the results shown in FIGS. 9a-9f. Notably, this inconsistency problem rarely occurs in the training-from-scratch process due to the high adaptivity of the value network.

To solve the inconsistency issue described above, modified policy functions are proposed in Hug-DRL and IA-RL. By dragging the policy's outputs, the effect of the policy-gradient-based update is weakened in the human-guided steps, which avoided the issue of the local optima trap. Thereafter, the policy could continue the noise-based exploration and gradient-based update in a space closer to the global optima. Theoretically, the inconsistency issue that occurred in HI-RL could be addressed by Hug-DRL and IA-RL. However, the experimental results show that IA-RL failed to achieve competitive performance as expected, mainly due to the different forms of human guidance. Generally, the reinforcement learning agent achieves asymptotic performance by large-scale batch training with the experience replay buffer. However, fine-tuning is essentially a learning process with small-scale samples. Thus, it is very difficult for IA-RL to find an appropriate learning rate in this situation, which leads to unstable fine-tuning performance. The weighting factor in the proposed Hug-DRL can automatically adjust the learning rate and mitigate this issue, hence achieving the best performance, as shown in FIGS. 8a-8e.

In addition to the training performance discussed above, the ability and superiority of the proposed method are validated in testing scenarios in comparison to other baseline approaches. More specifically, the effectiveness, adaptivity, and robustness of the proposed Hug-DRL method were tested under various driving tasks and compared the method to all related DRL baseline methods as well as vanilla-IL and DAgger. The results regarding the success rate across various testing scenarios, as shown in FIG. 14a, reflect the adaptivity of these methods. The proposed Hug-DRL achieved the best performance of all methods across all testing scenarios. The success rates of IL approaches are significantly affected by variations in the testing conditions, while the DRL methods maintained their performance and thus demonstrated better adaptivity. Meanwhile, DAgger outperformed vanilla-IL; its performance is similar to that of vanilla-DRL but lagged behind that of Hug-DRL. In terms of success rate, IA-RL and HI-RL performed worse than vanilla-DRL; this result differed from the previously observed results in the training process. A feasible explanation is that undesirable actions by human beings interrupted the original training distribution of the DRL and accordingly deteriorated the robustness. Similarly, according to the results shown in FIG. 14b, the average yaw rate and lateral acceleration of IA-RL and HI-RL are higher than those of vanilla-DRL, indicating their worse performance in motion smoothness. Hug-DRL achieved the highest performance, which demonstrates that beyond accelerating the training process, the proposed human guidance mechanism can achieve effective and robust control performance during the testing process.

The proposed Hug-DRL method is also investigated from the perspective of human factors. Real-time human guidance has proven effective for enhancing DRL performance; however, long-term supervision may also have negative effects, e.g., fatigue, on human participants. Fortunately, the results shown in FIG. 6e demonstrate that the intermittent guidance mode did not significantly deteriorate performance improvement compared to the continuous mode. Additionally, participants' subjective feelings on task workload under intermittent guidance are satisfactory, according to the survey results shown in FIG. 7. These results suggest that within the proposed human-in-the-loop DRL framework, human participants do not necessarily remain in the control loop constantly to supervise agent training. Intermittent guidance is a good option that generates satisfactory results for both agent training performance and human subjective feelings.

As the DRL performance improvement results illustrate in FIG. 6d, there is no significant difference between the proficient and non-proficient participant groups. This observation can be reasonably explained by the mechanism of the proposed algorithm. Assume that a standard DRL agent is in a specific state, and noise-based exploration can be effective only within a certain area close to the current state. Thus, the distribution is modified progressively and slowly based on the gradient update of the neural networks, which are far from convergent. However, in the designed Hug-DRL method, human guidance actions can facilitate the update of the distribution to be much more efficient. Thereafter, even if the guidance actions input from non-proficient participants are undesirable, the explorations leveraging human guidance are still more efficient than those in the standard DRL method.

In summary, the above findings suggest that the proposed Hug-DRL is advantageous over existing methods in terms of training efficiency and testing performance. It can effectively improve the agent's training performance in both the initial training and online fine-tuning stages. Intermittent human guidance can be a good option to generate satisfactory results for DRL performance improvement, and at the same time, it exerts no substantial burden on human workload. In particular, this new method largely reduces the requirements on the human side. Participating subjects do not need to be experts with a mastery of skilled knowledge or experience in specific areas. As long as they are able to perform normally with common sense, the DRL can be well trained and effectively improved, even if humans' actions are undesirable. These factors make the proposed approach very promising in future real-world applications. The high-level framework, the methodology employed, and the algorithms developed in this work have great potential to be expanded to a wide range of AI and human-AI interaction applications.

The human-in-the-loop driving simulator 400 shown in FIG. 4 is the experimental platform used for a range of experiments against which the present methods were assessed. The technical details and the specifications of the hardware and software are reported in Table 9, which shows configuration of the experimental platform. The experiments are carried out on a simulated driving platform. The software used in the platform is the CARLA simulator, which provides open-source codes supporting the flexible specification of sensor suites, environmental conditions, and full control of all static and dynamic automated-driving-related modules. The hardware of the platform contains a computer equipped with an NVIDIA GTX 2080 Super GPU, three joint heads-up monitors, a Logitech G29 steering wheel suit, and a driver seat. During the training process, participants observed the frontal-view images (captured from a camera fixed to the ego vehicle) through the screen, while the DRL agent received the semantic images as inputs. The control frequency of the ego vehicle and the frequency of data recording are both 20 Hz. After the human-in-the-loop training, the matured strategy for autonomous driving could execute in various testing scenarios. All the control codes and algorithms are programmed in the Python environment or another suitable language, and the deep neural networks are built leveraging the Pytorch framework.

TABLE 9

| | | |
|---|---|---|
| Driving | Simulation rendering software | CARLA |
| platform | Steering wheel suit | Logitech G29 |
| | CPU of the host computer | Intel i9-9900k |
| | GPU of the host computer | NVIDIA GTX2080 Super |
| | Monitoring device | Joint heads-up monitors × 3 |
| | Other equipment | Driver seat suit |
| Simulation | Control frequency | 20 Hz |
| configuration | Spawned vehicle type | Sedan |
| | Programming script | Python |
| | Neural network toolbox | Pytorch |

In total, six scenarios indexed from 0 to 5 are utilized in this investigation. The visualized scenarios are reported in FIGS. 11a-11e. The ego vehicle, i.e., the autonomous driving agent 1104 to be trained, the surrounding vehicles 1102 and pedestrians 1106 are all spawned in a two-lane road with a width of 7 metres. Scenario 0 is for DRL training; the relative velocity between the ego vehicle and the three surrounding vehicles (v_{ego}−v₁) is set to +5 m/s, and two pedestrians with random departure points in specific areas are set to cross the street. Scenarios 1 to 5 are for evaluating the robustness and adaptivity of learned policies under different methods. More specifically, in Scenario 1, all surrounding traffic participants are removed to examine whether the obtained policies could achieve steady driving performance on a freeway. In Scenario 2, the positions of all obstacle vehicles and pedestrians were changed, and the relative velocity between the ego vehicle and obstacle vehicles (v_{ego}−v₂) was set to +3 m/s, to generate a representative lane-change task in urban conditions for the ego vehicle. In Scenario 3, the coordinates of the surrounding vehicles are further changed to form an urban lane-keeping scenario. For Scenario 4, the relative velocities between the ego vehicle and the three obstacle vehicles are changed to (v_{ego}−v₃)=2 m/s, (v_{ego}−v₄)=+4 m/s, and (v_{ego}−v₅)=+3 m/s, respectively, and pedestrians are removed to simulate a highway driving scenario. In Scenario 5, pedestrians with different characteristics and various vehicle types were inserted into the traffic scenario, including motorcycles and buses.

Of the initial training conditions, the first condition is cold-start for initial training. The initial condition of training starting from scratch is denoted “cold-start”. Under this condition, the DRL agent had no prior knowledge about the environment except for the pre-initialized training. The second condition is pre-trained for fine-tuning. Under this condition, the initial training with the cold-start is completed by the agent under the standard DRL algorithm, and the agent is generally capable of executing the expected tasks. However, the behaviour of the agent could still be undesirable for some situations, and thus, the parameters of the algorithms are fine-tuned during this phase to further improve the agent's performance.

Regarding human intervention activation and termination, during the experiments the participants are not required to intervene in the DRL training at any certain time. Instead, they are required to initiate the intervention by operating the steering wheel, providing guidance to the agent whenever they felt it is necessary. The goal of their guidance tasks is to keep the agent on the road and try to avoid any collision with the road boundary or other surrounding obstacle vehicles. Once they feel that the agent is heading in the correct direction and behaving reasonably, human participants could disengage. The detailed activation and termination mechanisms set in the experiments are explained below.

Regarding intervention activation alone, if a steering angle of the hand wheel exceeding 5 degrees is detected, then the human intervention signal is activated and the entire control authority transferred to the human.

Regarding Intervention termination, if variation in the steering angle of the hand wheel is undetected after 0.2 s, then the human intervention is terminated and full control authority is transferred back to the DRL agent.

Under this framework, two human guidance modes are used. The first mode is intermittent guidance. In this mode, the participants are required to provide guidance intermittently. The entire training for a DRL agent in the designated scenario comprised 500 episodes, and human interventions are dispersed throughout the entire training process. More specifically, the participants are allowed to participate in only 30 episodes per 100 episodes, and they determined whether to intervene and when to provide guidance. For the rest of the time, the monitors are shut off to disengage the participants from the driving scenarios.

The second mode is called continuous guidance. In this mode, the participants are required to continuously observe the driving scenario and provide guidance when they feel it is needed throughout the entire training session.

The ability of the human to properly guide training is also useful to assess. The lower quality the human inputs, the lower the trustworthiness of those inputs and the lower the weight applied to losses between the modelled action and the human action. The proficiency of participants is defined as follows. The first to be considered is proficient subjects. Before the experiment, participants are first asked to naturally operate the steering wheel in a traffic scenario on the driving simulator for 30 minutes to become proficient in the experimental scenario and device operation. The second to be considered is non-proficient subjects. Participants are not asked to engage in the training session before participating in the experiment.

In addition to proficiency, driving qualifications are considered. The first driving qualification is qualified subjects. Participants with a valid driving licence are considered qualified subjects. The second driving qualification is unqualified subjects. Participants without a valid driving licence are regarded as unqualified subjects.

The effect of human proficiency and qualifications are then experimentally tested. The first test is Experiment A. The purpose of this experiment is to test the performance of the proposed Hug-DRL method and compare its performance with that of the selected baseline approaches. In total, ten participants holding a valid driving licence are included in this experiment. Before the experiment, the participants are asked to complete a 30-min training session on the driving simulator to become proficient in the experimental scenario and device operation. During the experiment, each participant is asked to provide intermittent guidance for the proposed Hug-DRL method and baseline methods, i.e., IA-RL and HI-RL. However, the participants are not informed about the different algorithms used in the tests. In addition, the vanilla-DRL method is used to conduct agent training 10 times without human guidance. The initial condition of the training is set as cold-start, and the driving scenario is set as the above-mentioned scenario 0. In addition, each participant is required to complete a questionnaire after their tests to provide their subjective opinion on the workload level, which is rated on a scale from one (very low) to five (very high).

The second is Experiment B. The purpose of this experiment is to assess the impact of the human guidance modes on the agent's performance improvement for the proposed Hug-DRL method. The same ten participants recruited in Experiment A are included in this experiment. Before the experiment, the participants are asked to complete a 30-min training session on the driving simulator to become proficient in the experimental scenario and device operation. During the experiment, each participant is asked to provide continuous guidance to the driving agent for the proposed Hug-DRL method. The initial condition of the training is set as cold-start, and the driving scenario is set as the above-mentioned scenario 0. In addition, each participant is required to complete a questionnaire after their tests to provide their subjective opinion on the workload level, which is rated on a scale from one (very low) to five (very high).

The third is Experiment C. The purpose of this experiment is to assess the impact of human proficiency and driving qualifications on the performance improvement of the proposed Hug-DRL method. Ten new subjects are recruited to participate in this experiment. Among them, five subjects holding valid driving licences are considered qualified participants, and the other five participants without a driving licence are considered unqualified participants. The participants are not provided with a training session before participating in the agent training experiment. During the experiment, each participant is asked to provide continuous guidance to the driving agent for the proposed Hug-DRL method. The initial condition of the training is set as cold-start, and the driving scenario is set as the above-mentioned scenario 0.

The fourth is Experiment D. The purpose of this experiment is to assess the online fine-tuning ability of the proposed Hug-DRL method and compare its fine-tuning ability to that of the selected baseline methods. In this experiment, the initial condition of the training is set as fine-tuning rather than cold-start. Fifteen new participants are recruited for this experiment. Before the experiment, the participants are provided with a short training session to become acclimated to the environment and the devices. The entire fine-tuning phase comprised 30 episodes in total. During the experiment, the subjects are allowed to intervene in the agent training only in the first 10 episodes, providing guidance when needed. For the next 20 episodes, the participants are disengaged from the tasks. However, the agent's actions are continually recorded to assess its performance. Each participant is asked to engage in this experiment under the proposed Hug-DRL method and the baseline methods, i.e., IA-RL and HI-RL. Before the experiment, the participants are not informed about the different algorithms used in the tests. The driving scenario of this experiment is set to scenario 0.

The fifth is Experiment E. The purpose of this experiment is to test the impacts of the adopted pre-initialized training and the reward-shaping techniques on training performance. In ablation group 1, five participants are required to complete the task in Experiment A, and the Hug-DRL agent used is not pre-trained by SL. The results are compared with those of the pre-trained Hug-DRL obtained in the training process. A similar set-up is used in ablation group 2, and the adopted Hug-DRL agents are equipped with three different types of reward schemes: no reward shaping, reward-shaping route 1, and reward-shaping route 2. In each subgroup experiment, 5 participants are asked to complete the task of c. The details of the different reward-shaping schemes are explained later in Eq. (24) and Eq. (25).

The sixth is Experiment F. The purpose of this experiment is to test and compare the performance of the autonomous driving agent trained by different methods under various scenarios. The training process of two imitation learning-based policies, i.e., vanilla-IL and Dagger, was first completed. Human participants were asked to operate the steering wheel, controlling the IL agent to complete the same overtaking manoeuvres as the DRL agents (collision avoidance with surrounding traffic participants). For vanilla-IL, the agent is fully controlled by human participants, and there is no agent to interact with humans through the transfer of control authority. Gaussian noise is injected into the agent's actions for the purpose of data augmentation. The collected data are used for offline SL to imitate human driving behaviours. For DAgger, the agent learned to improve its control capability from human guidance. In one episode, whenever a human participant felt the need to intervene, he or she obtained partial control authority, and only his or her guidance actions are recorded to train the DAgger agent in real time. Since the agent is refined through the training episodes, DAgger is expected to collect more data and obtain a more robust policy than vanilla-IL. The tested methods included Hug-DRL, IA-RL, HI-RL, vanilla-DRL, DAgger and vanilla-IL. The driving scenarios used in this experiment included designed scenarios 1-5.

As mentioned above, various baselines were used for testing. The first baseline is Intervention-aided DRL (IA-RL). In this method, human guidance is introduced into the agent training process. The human actions directly replaced the output actions of the DRL, and the loss function of the policy network is modified to fully adapt to human actions when guidance occurred. In addition, the algorithm penalized the DRL agent in human intervened events, which avoided the agent getting trapped into catastrophic states. This method is derived and named from existing work reported and is further modified in this work to adapt to the off-policy actor-critic DRL algorithms. The detailed algorithm for this approach can be found in Table 10, and the hyperparameters are listed in Tables 11-14. Table 10 shows the architecture of IA-RL algorithm. Table 11 illustrates hyperparameters used in the DRL algorithms. These parameters are universally applied to all involved DRL algorithms. Table 12 shows the details of the reinforcement learning architecture, applied to all related DRL algorithms. Table 13 shows the details of the imitation learning architecture, applied to Vanilla-IL and DAgger algorithms. Table 14 shows the architecture of the NGU network, applied to Reward shaping scheme 2

TABLE 10
Algorithm S2 IA-RL (off-policy version)

```
  Initialize the critic networks Q₁, Q₂, and actor network μ with random parameters.
  Initialize the target networks with the same parameters as their counterparts. Initialize the experience
replay buffer D.
  Initialize experience replay buffer D
  for epoch = 1 to M do
      for t = 1 to T do
    if the human participants does not intervene
          let I(sₜ) = 0, and select action with exploration noise αₜ ← αₜ~μ(sₜ) + ϵ, with ϵ~ [symbol]   (0,σ)
    Otherwise
        let I(sₜ) = 1, and adopt human action αₜ ← αₜ^{human}
    Observe reward rₜ and the new state sₜ₊₁ , terminal signal dₜ , store transition tuple
        {sₜ, αₜ, rₜ, dₜ, sₜ₊₁, I(sₜ)} in buffer D
    Sample minibatch of N tuples from D, calculate the target value of critic network as
yᵢ ← rᵢ + γ(1 − dᵢ) min_{j=1,2} Q^{′}ⱼ (sᵢ₊₁,μ^{′} (sᵢ₊₁)) , and update critic networks by: θ^{Qj} ←
ar gmin_{_{θ}}_{Qj}N⁻¹ Σᵢ^{N} (yᵢ − Qⱼ(sᵢ, αᵢ))²
    if t mod d then
      Update policy network u by the proposed loss function:
      ∇_{_{θ}}_{μ}L^{μ} = N⁻¹Σᵢ^{N}{(−∇_{α}Q₁(sᵢ, αᵢ)|_{α=μ(s}_{ᵢ}₎∇_{_{θ}}_{μ}μ(sᵢ)) · [1 − I(sᵢ)] + (∇_{_{θ}}_{μ}(ω_{I}(αᵢ − μ(sᵢ))²)) · I(sᵢ)}
      Update the target networks:
      θ^{Q′} ← τθ^{Q} + (1 − τ)θ^{Q′} for both target critic networks.
      θ^{μ′} ← τθ^{μ} + (1 − τ)θ^{μ′} for the target actor network.
    end if
      end for
end for
```

TABLE 11

| Parameter | Description (unit) | Value |
|---|---|---|
| Replay buffer size | The capacity of the experience replay buffer | 384000 |
| Maximum steps | Cutoff step number of the “cold- | 50000 |
| | start” training process | |
| Minibatch size (N) | Capacity of minibatch | 128 |
| Learning rate | Initial learning rate (policy/actor | 0.0005 |
| of actors | networks) with Adam optimizer | |
| Learning rate | Initial learning rate (value/critic | 0.0002 |
| of critics | networks) with Adam optimizer | |
| Initialization | Initialization method of Dense layers | he_initializer |
| | of the network | |
| Activation | Activation method of layers of the network | relu |
| Initial exploration | Initial exploration rate of noise in ϵ - greedy | 1 |
| Final exploration | Cutoff exploration rate of noise in ϵ - greedy | 0.01 |
| Gamma (γ) | Discount factor of the action-value | 0.95 |
| | function of value network | |
| Soft updating | Parameter transferring speed from | 0.001 |
| factor | policy/value networks to target | |
| | policy/value networks | |
| Noise scale | Noise amplitude of action in TD3 algorithm | 0.2 |
| Policy delay (d) | Updating frequency of value networks | 1 |
| | over policy networks | |

TABLE 12

| Parameter | Value |
|---|---|
| Input Image shape | [80, 45, 1] |
| Policy/actor Network | [6, 16] |
| Convolution | (kernel size 6 × 6) |
| Filter Features | |
| Policy/actor Network | Maxpooling |
| Pooling Features | (Stride 2) |
| Policy/actor Network | [256, 128, 64] |
| Fully Connected | |
| Layer Features | |
| Value/critic Network | [256, 256, 256] |
| Fully Connected | |
| Layer Features | |

TABLE 13

| Parameter | Value |
|---|---|
| Input Image shape | [80, 45, 1] |
| Network Convolution | [6, 16] |
| Filter Features | (kernel size 6 × 6) |
| Network Pooling | Maxpooling |
| Features | (Stride 2) |
| Network Fully | [256, 128, 64] |
| Connected | |
| Layer Features | |

TABLE 14

| Parameter | Value |
|---|---|
| Input Image shape | [80, 45, 1] |
| Network Convolution | [6, 16] |
| Filter Features | (kernel size 6 × 6) |
| Network Pooling | Maxpooling |
| Features | (Stride 2) |
| Network Fully | [128] |
| Connected | |
| Layer Features | |
| Network Initial | 0.0001 |
| Learning rate | |

The second baseline is human intervention DRL (HI-RL). In this method, human guidance is introduced into the agent training process; however, human actions are used to directly replace the output actions of the DRL agent without modifying the architecture of the neural networks. As a result, human actions affected only the update of the value network. In addition, the algorithm penalized the DRL agent in human intervened events, which avoided the agent being trapped into catastrophic states. This baseline approach is further modified to adapt the actor-critic DRL algorithm in our work. The detailed algorithm can be found in Table 15, and the hyperparameters are listed in Tables 12-14. Table 15 shows the architecture of HI-RL algorithm.

TABLE 15
Algorithm S3 HI-RL (off-policy version)

```
  Initialize the critic networks Q₁, Q₂, and actor network μ with random parameters.
  Initialize the target networks with the same parameters as their counterparts. Initialize experience
replay buffer D.
  Initialize the experience replay buffer D
  for epoch = 1 to M do
      for t = 1 to T do
    if the human driver does not intervene
          let I(sₜ) = 0, and select action with exploration noise αₜ ← αₜ~μ(sₜ) + ϵ, with ϵ~ [symbol]   (0,σ)
    Otherwise
        let I(sₜ) = 1, and adopt human action αₜ ← αₜ^{human}
    Observe reward rₜ and the new state sₜ₊₁ , terminal signal dₜ , store transition tuple
      {sₜ, αₜ, rₜ, dₜ, sₜ₊₁, I(sₜ)} in buffer D
    Sample minibatch of N tuples from D, calculate the target value of critic network as
yᵢ ← rᵢ + γ(1 − dᵢ) min_{j=1,2} Q^{′}ⱼ (sᵢ₊₁,μ^{′} (sᵢ₊₁)) , and update critic networks by: θ^{Qj} ←
ar gmin_{_{θ}}_{Qj}N⁻¹ Σᵢ^{N} (yᵢ − Qⱼ(sᵢ, αᵢ))²
    if t mod d then
      Update the policy network u by the loss function:
      ∇_{_{θ}}_{μ}L^{μ} = N⁻¹ Σᵢ^{N}{(−∇_{α}Q₁(sᵢ, aᵢ)|_{α=μ(s}_{ᵢ}₎∇_{_{θ}}_{μ}μ(sᵢ))}
      Update the target networks:
      θ^{Q′} ← τθ^{Q} + (1 − τ)θ^{Q′} for both target critic networks.
      θ^{μ′} ← τθ^{μ} + (1 − τ)θ^{μ′} for the target actor network.
    end if
      end for
end for
```

The third baseline is Vanilla-DRL. This standard DRL method (the TD3 algorithm) is used as a baseline approach in this work. The detailed algorithm can be found in Table 16, and the hyperparameters are listed in Tables 12-14. Table 16 shows the architecture of vanilla-DRL algorithm.

TABLE 16
Algorithm S4 vanilla-DRL (Twin delayed deep deterministic policy gradient)

```
  Initialize the critic networks Q₁, Q₂, and actor network μ with random parameters.
  Initialize the target networks with the same parameters as their counterparts. Initialize the experience
replay buffer D.
  for epoch = 1 to M do
    for t = 1 to T do
    select action with exploration noise αₜ ← αₜ~μ(sₜ) + ϵ, with ϵ~ [symbol]   (0,σ)
    Observe reward rₜ and the new state sₜ₊₁ , terminal signal dₜ , store transition tuple
{sₜ, αₜ, rₜ, dₜ, sₜ₊₁} in buffer D
    Sample minibatch of N tuples from D, calculate the target value of critic network as
yᵢ ← rᵢ + γ(1 − dᵢ) min_{j=1,2} Q^{′}ⱼ (sᵢ₊₁,μ^{′} (sᵢ₊₁)) , and update critic networks by: θ^{Qj} ←
ar gmin_{_{θ}}_{Qj}N⁻¹ Σᵢ^{N} (yᵢ − Qⱼ(sᵢ, αᵢ))²
    if t mod d then
      Update the policy network u by the loss function:
      ∇_{_{θ}}_{μ}L^{μ} = N⁻¹Σᵢ^{N}{(−∇_{α}Q₁(sᵢ, aᵢ)|_{a=μ(s}_{ᵢ}₎∇_{_{θ}}_{μ}μ(sᵢ))}
      Update the target networks:
      θ^{Q′} ← τθ^{Q} + (1 − τ)θ^{Q′} for both target critic networks.
      θ^{μ′} ← τθ^{μ} + (1 − τ)θ^{μ′} for the target actor network.
    end if
      end for
end for
```

The fourth baseline is Vanilla Imitation Learning (Vanilla-IL). Vanilla IL with data augmentation is also adopted as a baseline method. A deep neural network with the vanilla-IL method is used to develop the autonomous driving policy for comparison with other DRL-based approaches. The detailed mechanism of this method is introduced in FIGS. 12a-12f. The hyperparameters are listed in Table 18, and the network architecture is illustrated in Tables 12-14.

The detailed procedures of data collection and model training under Vanilla-IL are introduced here. The data collection session required human participants to complete driving tasks in Scenario 0, and the state inputs (frontal-view images) and action outputs (steering angles) are recorded throughout the demonstration process. A data augmentation technique with noise added was adopted to solve the distributional shift problem, referring to FIG. 12b. Specifically, random Gaussian noises were added into humans' steering commands. Accordingly, the controlled vehicle visited varying unexpected states, and human drivers need to adjust their control actions to avoid unexpected risks. In this way, more demonstrations showing how to recover from failures are collected to train the vanilla-IL-based policy. Note that human actions were recorded without considering the added noises. FIGS. 12d-12f illustrate the effect of the data augmentation technique.

The policy network, which was established on a convolution neural network (CNN), received semantic images and output steering commands. State-action pairs from the dataset were constantly sampled to update network parameters. The loss function can be expressed as:

$${L}^{C} ( {θ}^{C} ) = {𝔼}_{( {s}_{t} , {y}_{t} ) \cdot {D}_{IL}} [ {( C ( {s}_{t} ) - {y}_{t} )}^{2} ] \qquad ( 12 )$$

where C denotes the CNN-based policy network, θ^{C} denotes network parameters, sₜ denotes input data at the time step t, yₜ denotes labels, i.e., actions from human participants, and D_{IL} denotes the entire dataset. Detailed parameters are provided in Tables 12-14 and 17. Table 17 shows Hyperparameters used in the DAgger imitation learning-based strategy.

TABLE 17

| Parameter | Description (unit) | Value |
|---|---|---|
| Learning | Initial learning rate with | 0.00001 |
| rate | Adam optimizer | |
| Initialization | Initialization method of | he_initializer |
| | dense layers of the network | |
| Activation | Activation method of layers | relu |
| | (except the last layer) | |
| Maximum | Cutoff episode number of | 50 |
| episodes | the training process | |
| Activation | Activation function of | None |
| | the last layer | |
| Batch | Capacity of minibatch | 128 |
| size | | |

To collect data, one or more data collection sessions were conducted. Each data collection session required human participants to complete one episode in scenario 0 with the same inputs/outputs as those of the vanilla-IL-based strategy. The human demonstration data are then utilized to pre-train the DAgger agent. To solve the distributional shift problem, this method allows the pre-trained agent to perform explorations in multiple episodes. When the distribution of the training data shifted to that of untrained situations, human participants are required to intervene and share the control authority with the DAgger agent, correcting undesirable behaviours. The control authority assignment mechanism can be given by:

ₜ=βaₜ^{agent}+(1−β)aₜ^{human} (13)

where β=0.5 denotes the authority of the DAgger agent when shared control occurs.

The actions of human participants, i.e., demonstrations, into the dataset, were recorded and DAgger agent can learn from demonstrations. The loss function can be expressed as:

$${L}^{D} ( {θ}^{D} ) = {𝔼}_{( {s}_{t} , {y}_{t} ) ∼ {D}_{DAgger}} [ {( C ( {s}_{t} ) - {y}_{t} )}^{2} ] \qquad ( 14 )$$

where D denotes the CNN-based policy network, θ^{D} denotes network parameters, sₜ denotes input data at the time step t, yₜ denotes labels, i.e., actions from the human participants, and D_{DAgger} denotes the entire dataset. The schematic diagram of the DAgger method is provided in FIGS. 13a-13b, and detailed parameters are provided in Tables 17 and 18. Table 18 shows Hyperparameters used in the vanilla imitation learning-based strategy.

TABLE 18

| Parameter | Description (unit) | Value |
|---|---|---|
| Learning | Initial learning rate with | 0.00001 |
| rate | Adam optimizer | |
| Initialization | Initialization method of dense | he_initializer |
| | layers of the network | |
| Activation | Activation function of layers | relu |
| | (except the last layer) | |
| Activation | Activation function of the | None |
| | last layer | |
| Batch | Capacity of minibatch | 128 |
| size | | |
| Noise | Noise amplitude of action | 0.1 |
| scale | in data augmentation | |

The fifth baseline is dataset Aggregation Imitation Learning (DAgger). This is an IL method with real-time human guidance. Under this approach, human participants serve as experts to supervise and provide necessary guidance to an actor agent that learns from human demonstrations and improves its performance through training. The detailed mechanism of DAgger is illustrated in FIGS. 12a-12b. The detailed procedures of data collection and model training are the same as those of Vanilla-IL based strategy. The hyperparameters are listed in Table 17, and the network architecture is illustrated in Tables 12-14.

The proposed Hug-DRL can then be implemented for autonomous driving. The proposed Hug-DRL method is developed based on TD3 with the introduction of real-time human guidance. For the DRL algorithm, appropriate selections of the state and action space, as well as the elaborated reward function design, are significant for efficient model training and performance achievement. In this work, the target tasks for the autonomous driving agent are set to complete lane changing and overtaking under various designed scenarios. To better demonstrate the feasibility, effectiveness and superiority of the proposed method, the challenging end-to-end paradigm is selected as the autonomous driving configuration for proof of concept. Specifically, non-omniscient state information is provided to the policy, and the state representation is selected for semantic images of the driving scene through a single channel representing the category of 45×80 pixels:

sₜ={p_{ij,t}|p∈[0,1]}_{45×80}, (15)

where pᵢⱼ is the channel value of pixel i×j normalized into [0,1]. The semantic images are obtained from the sensing information provided by the simulator.

The steering angle of the hand wheel is selected as the one-dimensional action variable, and the action space can be expressed as

aₜ={αₜ|α∈[0,1]} (16)

where α is the steering wheel angle normalized into [0,1], where the range [0,0.5) denotes the left-turn command and (0.5,1] denotes the right-turn command. The extreme rotation angle of the steering wheel is set to ±135 degrees.

The reward function should consider the requirements of real-world vehicle applications, including driving safety and smoothness. The basic reward function is designed as a weighted sum of the metrics, which is given by

rₜ=τ₁c_{side,t}+τ₂c_{front,t}+τ₃c_{smo,t}+τ₄c_{fail,t} (17)

where c_{side,t} denotes the cost of avoiding a collision with the roadside boundary, c_{front,t} is the cost of collision avoidance with an obstacle vehicle to the front, c_{smo,t} is the cost of maintaining vehicle smoothness, and c_{fail,t} is the cost of a failure that terminates the episode. τ₁ to τ₄ are the weights of each metric.

The cost of a roadside collision is defined by a two-norm expression as

c_{side,t}=−∥1−f_{sig}(min[d_{left,t},d_{right,t}])∥₂ (18)

where d_{left} and d_{right} are the distances to the left and right roadside boundaries, respectively. f_{sig} is the sigmoid-like normalization function transforming the physical value into [0,1].

The cost of avoiding an obstacle to the front is defined by a two-norm expression as

$${c}_{front , t} = \{ \begin{matrix}- {‖ 1 - {f}_{sig} ( {d}_{front} ) ‖}_{2} & , if a front obstacle exists \\ 0 & , otherwise\end{matrix} \qquad ( 19 )$$

where d_{front} is the distance to the front-obstacle vehicle in the current lane.

The cost of maintaining smoothness is

$${c}_{smo , t} = - ( \frac{d {α}_{t}}{dt} + ( {α}_{t} - 0.5 ) ) \qquad ( 20 )$$

The cost of failure can be expressed as

$${c}_{fail , t} = \{ \begin{matrix}- 1 & if fail \\ 0 & otherwise\end{matrix} \qquad ( 21 )$$

The above reward signals stipulate practical constraints. However, the feedback is still sparse and does not boost exploration behaviours, which means that the DRL could easily become trapped in the local optima. The reward-shaping technique is an effective tool to prevent this issue. Reward shaping transforms the original rewards by constructing an additional function with the aim of improving performance. Three kinds of reward-shaping methods were utilized and conduct an ablation investigation to explore their utilities in Experiment E.

First, human intervention penalty-based reward shaping is introduced. A typical intervention penalty function [symbol] : [symbol] × [symbol] → [symbol] can be written as

[symbol]

ₜ¹(sₜ₋₁,sₜ)=−10˜{[I(sₜ)=1]\hat{ }[I(sₜ₋₁)=0]} (22)

Human interventions aims to correct the DRL agent's behaviour and avoid catastrophic states. Hence, this equation suggests that a penalty signal is added to the original reward when humans decide to intervene at a specific state. To pursue high cumulative rewards, the DRL agent should avoid human intervention by decreasing visits to harmful states. The intervention penalty is triggered only at the first time step when a human intervention event occurs. The rationale behind this is that once human manipulation begins, intervention usually lasts at least several time steps, but only the first intervention time step can be confirmed as a participant judged “harmful” state/behaviour.

Another form of reward shaping relies on a potential function, which is well known for its straightforward and efficient implementation. A typical potential-based reward-shaping function [symbol] : [symbol] × [symbol] × [symbol] → [symbol] can be written as

[symbol]

(sₜ,aₜ,sₜ₊₁)=γϕ(sₜ₊₁)−ϕ(sₜ)∀sₜ∈ [symbol] (23)

where ϕ: [symbol] → [symbol] is a value function, which ideally should be equal to [symbol] _{a˜π(⊇|s)}[Q(s,a)]. Since the accurate values of Q are intractable before training convergence, prior knowledge regarding the task requirement becomes a heuristic function ϕ to incentivize the DRL's exploration. Accordingly, the function [symbol] ² in adopted method 1 is defined to be associated with the longitudinal distance from the spawn point, which can be calculated as

[symbol]

ₜ²=P_{y,t}(sₜ,aₜ)−P_{y,spawn} (24)

where P_{y,t} and P_{y} spawn are the current and initial positions of the agent in the longitudinal direction, respectively. This indicates that the agent is encouraged to move forward and explore further, keeping itself away from the spawn position.

The last reward-shaping method is a state-of-the-art technique named NGU. Its main idea is also to encourage exploration and prevent frequent visits of previously observed state values.

$${ℱ}_{t}^{3} = {r}_{t}^{episode} \cdot min \{ max \{ 1 + \frac{‖ f ( {s}_{t + 1} \vert ψ ) - f ( {s}_{t + 1} ) ‖ - 𝔼 [ f ( {s}_{t + 1} \vert ψ ) ]}{σ [ f ( {s}_{t + 1} \vert ψ ) ]} , 1 \} , L \} \qquad ( 25 )$$

where f(⋅|ψ)) and f(⋅) are embedded neural networks with fixed weights and adjustable weights, respectively. The norm ∥⋅∥ is to calculate the similarity between the embedded state feature; σ denotes the SD operation, and L is a regularization hyperparameter. The overall idea of employing f(⋅) is to assign higher additional rewards to unvisited states, particularly during the training process. rₜ^{episode} also encourages exploration in unvisited states, particularly during the current episode. The utilized hyperparameters are provided in Tables 12-14.

Thus, the overall reward function can be obtained by adding the terms and [symbol] ₜ¹, [symbol] ₜ², and [symbol] ₜ³ to the original function rₜ.

Finally, the termination of an episode with successful task completion occurs when the last obstacle vehicle is passed and the finishing line is reached without any collisions. With the above steps, the detailed implementation of the standard DRL in the designed driving scenario is completed.

For the proposed Hug-DRL, real-time human guidance is achieved by operating the steering wheel in the experiments. Thus, the steering angle of the hand wheel is used as the human intervention signal, and a threshold filtering unexpected disturbance is required. Here, the event of human intervention and guidance is

$$I ( {s}_{t} ) = \{ \begin{matrix}1 , if ( \frac{d {α}_{t}}{dt} > {ε}_{1} ) ⋂ ¬ q \\ 0 , otherwise\end{matrix} \qquad ( 26 )$$

where ε₁ is the threshold, set as 0.02. q denotes the detection mechanism of human intervention termination, which is defined as

$$q = {\prod }_{t}^{t + {t}_{N}} ( \frac{d {α}_{t}}{dt} < {ε}_{2} ) \qquad ( 27 )$$

where ε₂ is the threshold, set to 0.01. t_{N} is the time threshold for determining the intervention termination, and it is set to 0.2 s, as mentioned above.

For the proposed Hug-DRL method, when human participants engage in or disengage from the training process, the control authority of the agent is transferred between the human and the DRL algorithm in real time. The detailed mechanism of control transfer is illustrated in Eq. (2).

In total, 40 participants (26 males, 14 females) in the age range of 34 to 21 (M=27.43, SD=3.02) are recruited for the experiments. A statistical analysis of the experimental data was conducted for the designed experiments in MATLAB (R2020a, MathWorks) using the Statistics and Machine Learning Toolbox and in Microsoft Excel. For the data shown in FIGS. 5a-5d, 8a-8e, and 14a-14f, since these data generally obeyed a normal distribution, the difference in the mean values between two groups is determined using paired t-tests (with the threshold level α=0.05), and the difference for multiple groups is determined using one-way ANOVA. To investigate the statistical significance of the difference between the data groups, as shown in FIGS. 6a-6g, non-parametric tests, including the Mann-Whitney U-test and the Kruskal-Wallis test, are adopted at the α=0.05 threshold level.

The following evaluation metrics were then adopted to evaluate the agent's performance. The reward, reflecting the agent's performance, is chosen as the first metric. For both the step reward and the episodic reward, the mean and SD values are calculated and used when evaluating and comparing the agent's performance across different methods and different conditions. The length of the episode, which is obtained by calculating the number of steps in one episode, is also selected as an evaluation metric to reflect the current performance and learning ability of the agent. Another metric adopted is the intervention rate, which reflected the frequency of human intervention and guidance. The intervention rate can be represented in two ways, i.e., count by episode and count by step. The former is calculated based on the total number of steps guided by a human in a specific episodic interval, and the latter is calculated based on the number of episodes in which a human intervened. The success rate is defined as the percentage of successful episodes within total episodes throughout the testing process. The vehicle dynamic states, including the lateral acceleration and the yaw rate, are selected to evaluate the dynamic performance and stability of the agent vehicle.

In general, disclosed herein is also a system for autonomous control of a machine. The system com-prising storage; and at least one processor in communication with the storage. The storage comprises machine-readable instructions for causing the at least one processor to execute a method described above, in training a deep reinforcement learning model for autonomous control of the machine.

The present invention also relates to a non-transitory storage comprising machine-readable instructions for causing at least one processor to execute a method described above, in training a deep reinforcement learning model for autonomous control of a machine and the method for autonomous control of the machine using the trained deep reinforcement learning model.

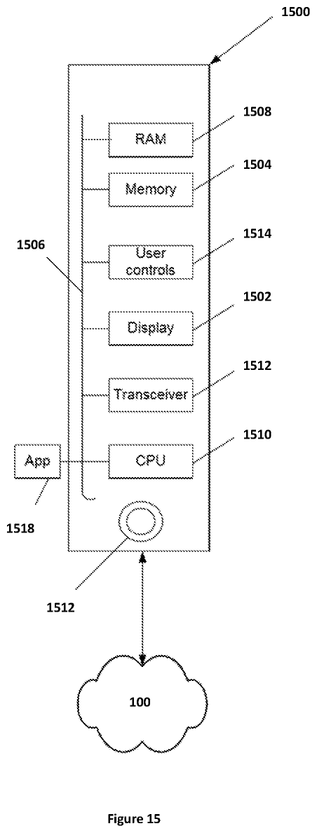

FIG. 15 is a block diagram showing an exemplary computer device 1500, in which embodiments of the invention may be practiced. The computer device 1500 may be a mobile computer device such as a smart phone, a wearable device, a palm-top computer, and multimedia Internet enabled cellular telephones when used in training the model, and, for use in controlling a vehicle or other machine for autonomous driving, may be an on-board computing system or a mobile device such as an iPhone™ manufactured by Apple™, Inc or one manufactured by LG™, HTC™ and Samsung™, for example, or other device in communication with the vehicle or other machine and configured to send control commands thereto and to receive information on human interventions from the vehicle or other machine.

As shown, the mobile computer device 1500 includes the following components in electronic communication via a bus 1506:
(a) a display 1502;
(b) non-volatile (non-transitory) memory 1504;
(c) random access memory (“RAM”) 1508;
(d) N processing components 1510;
(e) a transceiver component 1512 that includes N transceivers; and
(f) user controls 1514.

Although the components depicted in FIG. 15 represent physical components, FIG. 15 is not intended to be a hardware diagram. Thus, many of the components depicted in FIG. 15 may be realized by common constructs or distributed among additional physical components. Moreover, it is certainly contemplated that other existing and yet-to-be developed physical components and architectures may be utilized to implement the functional components described with reference to FIG. 15.

The display 1502 generally operates to provide a presentation of content to a user, and may be realized by any of a variety of displays (e.g., CRT, LCD, HDMI, micro-projector and OLED displays).

In general, the non-volatile data storage 1504 (also referred to as non-volatile memory) functions to store (e.g., persistently store) data and executable code. The system architecture may be implemented in memory 1504, or by instructions stored in memory 1504.

In some embodiments for example, the non-volatile memory 1504 includes bootloader code, modem software, operating system code, file system code, and code to facilitate the implementation components, well known to those of ordinary skill in the art, which are not depicted nor described for simplicity.

In many implementations, the non-volatile memory 1504 is realized by flash memory (e.g., NAND or ONENAND memory), but it is certainly contemplated that other memory types may be utilized as well. Although it may be possible to execute the code from the non-volatile memory 1504, the executable code in the non-volatile memory 1504 is typically loaded into RAM 1508 and executed by one or more of the N processing components 1510.

The N processing components 1510 in connection with RAM 1508 generally operate to execute the instructions stored in non-volatile memory 1504. As one of ordinarily skill in the art will appreciate, the N processing components 1510 may include a video processor, modem processor, DSP, graphics processing unit (GPU), and other processing components.

The transceiver component 1512 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The system 1500 of FIG. 15 may be connected to any appliance 418, such as one or more cameras mounted to the vehicle, a speedometer, a weather service for updating local context, or an external database from which context can be acquired.

It should be recognized that FIG. 15 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 1504. Non-transitory computer-readable medium 1504 includes both computer storage medium and communication medium including any medium that facilitates transfer of a computer program from one place to another. A storage medium may be any available medium that can be accessed by a computer.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

1. A method of training a deep reinforcement learning model for autonomous control of a machine, the model being configured to output, by a policy network, an agent action in response to input of state information and a value function, the agent action representing a control signal for the machine, the method comprising:
minimizing a loss function of the policy network;
wherein the loss function of the policy network comprises an autonomous guidance component and a human guidance component; and
wherein the autonomous guidance component is zero when the state information is indicative of input of a human input signal at the machine.

2. The method according to claim 1, wherein the model has an actor-critic architecture comprising an actor part and a critic part, and wherein the actor part comprises the policy network.

3. The method according to claim 2, wherein the critic part comprises at least one value network configured to output the value function.

4. The method according to claim 3, wherein the at least one value network is configured to estimate the value function based on the Bellman equation.

5. The method according to claim 3, wherein the critic part comprises a first value network paired with a second value network, each value network having the same architecture, for reducing or preventing overestimation.

6. The method according to claim 3, wherein each value network is coupled to a target value network.

7. The method according to laim 1, wherein the policy network is coupled to a target policy network.

8. The method according to claim 1, wherein the deep reinforcement learning model comprises a priority experience replay buffer for storing, for a series of time points: the state information; the agent action; a reward value; and an indicator as to whether a human input signal is received.

9. The method according to laim 1, wherein the machine is an autonomous vehicle.

10. The method according to claim 1, wherein the loss function includes an adaptively assigned weighting factor applied to the human guidance component.

11. The method according to claim 10, wherein the weighting factor comprises a temporal decay factor.

12. The method according to claim 10, wherein the weighting factor comprises an evaluation metric for evaluating a trustworthiness of the human guidance component.

13. A method for autonomous control of a machine, comprising:
obtaining parameters of a trained deep reinforcement learning model trained by a method according to claim 1;
receiving state information indicative of an environment of the machine;
determining, by the trained deep reinforcement learning model in response to input of the state information, an agent action indicative of a control signal; and
transmitting the control signal to the machine.

14. A system for training a deep reinforcement learning model for autonomous control of a machine, the system comprising:
storage; and
at least one processor in communication with the storage;
wherein the storage comprises machine-readable instructions for causing the at least one processor to execute a method according to claim 1.

15-16. (canceled)
